(19) United States
(12) Patent Application Publication
(10) Pub. No.: US 2025/0282945 A1
(43) Pub. Date: Sep. 11, 2025

(54) CURABLE RESIN COMPOSITION AND ELECTRONIC COMPONENT DEVICE

(71) Applicant: RESONAC CORPORATION, Tokyo (JP)

(72) Inventors: Tomoo NISHIYAMA, Minato-ku, Tokyo (JP); Takaya YAMAMOTO, Minato-ku, Tokyo (JP); Ayako TAIRA, Minato-ku, Tokyo (JP)

(73) Assignee: RESONAC CORPORATION, Tokyo (JP)

(21) Appl. No.: 18/861,598

(22) PCT Filed: Dec. 11, 2023
(86) PCT No.: PCT/JP2023/044232

§ 371 Date: Oct. 30, 2024

(30) Foreign Application Priority Data
Dec. 16, 2022 (JP) 2022-201454
Dec. 16, 2022 (JP) 2022-201455
Dec. 16, 2022 (JP) 2022-201456

(51) Int. Cl. C08L 63/00; C08G 59/30; C08G 59/38; C08G 59/62; C08K 3/04; C08K 5/5397; C08K 5/541; C08K 5/5445; C08K 5/548; C08K 7/20

(52) U.S. Cl. CPC C08L 63/00; C08G 59/302; C08G 59/38; C08G 59/621; C08K 3/04; C08K 5/5397; C08K 5/541; C08K 5/5445; C08K 5/548; C08K 7/20; C08K 2201/005; C08L 2203/206; C08L 2205/035; C08L 2312/04

(57) ABSTRACT

The first curable resin composition contains a triphenylmethane epoxy resin having at least one selected from the group consisting of alkyl groups and alkoxy groups. The second curable resin composition contains a polysiloxane stress reliever and a triphenylmethane epoxy resin having at least one selected from the group consisting of alkyl groups and alkoxy groups. The third curable resin composition, when made into a cured product, has an elastic modulus at 260° C. of 400 MPa or less, a linear expansion coefficient at 180-200° C. of 32 ppm/° C. or more, and an adhesive strength of the cured product to Ag (silver) after treatment at 85° C. and 85% RH of 0.45 MPa or more.

### TECHNICAL FIELD

The present disclosure relates to a curable resin composition and an electronic component device.

### RELATED ART

Semiconductor elements have become increasingly densely packed in recent years. Accordingly, the mainstream of resin-sealed semiconductor devices is shifting from the conventional pin-insertion type packages to the surface-mount type packages. Surface-mount type ICs (Integrated Circuits), LSIs (Large Scale Integrations), or the like are thin and small packages in order to increase the packaging density and reduce the packaging height. Therefore, the area occupied by the element in the package is increasing, and the thickness of the package is becoming very thin.

Furthermore, these packages are mounted differently from pin-insertion type packages. That is, the pin-insertion type package has a structure that, after the pin is inserted into the wiring board, soldering is performed from the back surface of the wiring board, so that the package is not directly exposed to high temperature.

However, since the surface-mount type IC is temporarily attached to the surface of the wiring board and then processed with a solder bath, a reflow device, etc., the package is directly exposed to the soldering temperature (reflow temperature). As a result, if the package absorbs moisture, the absorbed moisture may evaporate during reflow, and the generated vapor pressure may act as peeling stress and cause peeling between the sealing material and the support member such as an element and a lead frame, resulting in package cracks and poor electrical characteristics. Therefore, there is a demand for the development of a sealing material that has excellent adhesion to the support member and thus excellent solder heat resistance (reflow resistance).

Patent Document 1 proposes a curable resin composition including an epoxy resin, a curing agent, a curing accelerator, an inorganic filler, and an alkoxysilane polymer having a specific structure, as a sealing material having excellent reflow resistance.

Furthermore, in order to improve reflow resistance, for example, the surface of the lead frame is roughened before plating treatment to improve adhesion to the sealing material.

### CITATION LIST

### Patent Document

Patent Document 1: Japanese Patent Application Laid-Open No. 2008-111101

### SUMMARY OF INVENTION

### Technical Problem

There is a demand for the development of a sealing material that suppresses pealing from a lead frame even under more severe moisture absorption conditions.

The present disclosure has been made in view of the above-mentioned circumstances, and aims to provide a curable resin composition that suppresses peeling from a lead frame even when the cured product is subjected to moisture absorption under conditions of 85° C. and 85% RH, and an electronic component device including an element sealed with this curable resin composition.

### Solution to Problem

<1> A curable resin composition includes a triphenylmethane type epoxy resin having at least one selected from a group consisting of an alkyl group and an alkoxy group.

<2> In the curable resin composition according to <1>, a benzene ring included in the triphenylmethane type epoxy resin has two or more alkyl groups.

<3> In the curable resin composition according to <1> or <2>, a benzene ring included in a main chain of the triphenylmethane type epoxy resin has two or more alkyl groups.

<4> In the curable resin composition according to any one of <1> to <3>, the alkyl group includes a t-butyl group.

<5> The curable resin composition according to any one of <1> to <4> further includes a polysiloxane-based stress reliever.

<6> In the curable resin composition according to <5>, the polysiloxane-based stress reliever includes a branched polysiloxane having the following structural units (a) and (b), a terminal of which is at least one functional group selected from a group consisting of R¹, a hydroxyl group, and an alkoxy group, and having an epoxy equivalent of 500 g/eq to 4,000 g/eq,

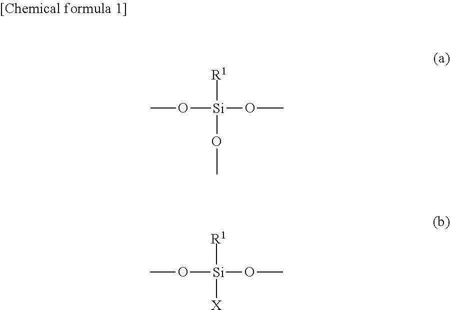

[R¹ represents an unsubstituted alkyl group, alkenyl group, aryl group, or aralkyl group having 1 to 12 carbon atoms, and in a case where a plurality of R¹ are present in the branched polysiloxane, the plurality of R¹ may be the same or different; X represents a 2,3-epoxypropyl group, a 3,4-epoxybutyl group, a 4,5-epoxypentyl group, a 2-glycidoxyethyl group, a 3-glycidoxypropyl group, a 4-glycidoxybutyl group, a 2-(3,4-epoxycyclohexyl)ethyl group, or a 3-(3,4-epoxycyclohexyl)propyl group.]

<7> A curable resin composition has an elastic modulus at 260° C. of 400 MPa or less when made into a cured product, a linear expansion coefficient at 180° C. to 200° C. of 32 ppm/° C. or more when made into a cured product, and an adhesive strength of the cured product to Ag (silver) after treatment at 85° C. and 85% RH of 0.45 MPa or more.

<8> The curable resin composition according to <7> has a spiral flow according to EMMI-1-66 of 100 cm or more.

<9> The curable resin composition according to <7> or <8> has a hot hardness of 56 or more when made into a cured product.

<10> The curable resin composition according to any one of <7> to <9> has a hot strength of 3 MN/m² or more when made into a cured product.

<11> An electronic component device includes an element; and a cured product of the curable resin composition according to any one of <1> to <10> that seals the element.

<12> The electronic component device according to <11> includes a lead frame mounting the element on one surface.

<13> In the electronic component device according to <12>, the lead frame includes Ag.

### Effects of Invention

According to the present disclosure, it is possible to provide a curable resin composition that suppresses peeling from a lead frame even when the cured product is subjected to moisture absorption under conditions of 85° C. and 85% RH, and an electronic component device including an element sealed with this curable resin composition.

### DESCRIPTION OF EMBODIMENTS

Embodiments of the present disclosure will be described in detail hereinafter. However, the present disclosure is not limited to the following embodiments. In the following embodiments, the constituent elements (including element steps, etc.) are not essential, unless otherwise specified. The same applies to numerical values and ranges thereof, which do not limit the present disclosure.

In the present disclosure, the numerical range indicated using “to” includes the numerical values before and after “to” as the minimum value and the maximum value, respectively.

In the present disclosure in which numerical ranges are described in stages, the upper or lower limit described in one numerical range may be replaced with the upper or lower limit of another numerical range described in stages. In addition, in the numerical range described in the present disclosure, the upper or lower limit of the numerical range may be replaced with a value shown in the synthesis examples.

In the present disclosure, each component may include multiple types of corresponding compounds. In the case where a composition includes multiple types of substances corresponding to each component, the content or amount of each component means the total content or amount of the multiple types of substances present in the composition, unless otherwise specified.

In the present disclosure, each component may include multiple types of corresponding particles. In the case where a composition includes multiple types of particles corresponding to each component, the particle size of each component means the value with respect to a mixture of the multiple types of particles present in the composition, unless otherwise specified.

In the present disclosure, the term “lamination” refers to stacking layers, wherein two or more layers may be bonded together or two or more layers may be removable.

In the description of groups (atomic groups) in the present disclosure, the description without specifying whether substituted or unsubstituted includes groups having a substituent as well as groups having no substituent.

In the present disclosure, the number of structural units represents an integer value for a single molecule, but represents a rational number that is an average value for an aggregate of multiple types of molecules.

In the present disclosure, the number of carbon atoms means the total number of carbon atoms included in an entire group, and represents the number of carbon atoms forming the skeleton of the group in the case where the group has no substituent and represents the total number obtained by adding the number of carbon atoms forming the skeleton of the group to the number of carbon atoms in the substituent in the case where the group has a substituent.

In the present disclosure, the weight average molecular weight (Mw) is a value measured using the following GPC (Gel Permeation Chromatography) measuring device under the following measurement conditions and converted using a calibration curve of standard polystyrene. However, for a compound whose Mw cannot be accurately measured by GPC due to a small molecular weight, the molecular weight calculated from the chemical structure of the compound is used as the Mw, Mn, or degree of polymerization of the compound.

The following is an example of the measuring device, and the calibration curve may be created using a 5-sample set of standard polystyrene (“PStQuick MP-H” and “PStQuick B,” manufactured by Tosoh Corporation).

### (GPC Measuring Device)

GPC device: high-speed GPC device “HCL-8320GPC,” the detector is a differential refractometer or UV, manufactured by Tosoh Corporation
Column: column TSKgel Super Multipore HZ-H (column length: 15 cm, column inner diameter: 4.6 mm), manufactured by Tosoh Corporation

### (Measurement Conditions)

Solvent: tetrahydrofuran (THF)
Measurement temperature: 40° C.
Flow rate: 0.35 mL/min
Sample concentration: 10 mg/THF 5 mL
Injection amount: 20 μL

### <Curable Resin Composition>

The first curable resin composition of the present disclosure includes a triphenylmethane type epoxy resin having at least one selected from the group consisting of an alkyl group and an alkoxy group. Hereinafter, the “triphenylmethane type epoxy resin having at least one selected from the group consisting of an alkyl group and an alkoxy group” is also referred to as the “specific triphenylmethane type epoxy resin.”

The first curable resin composition of the present disclosure suppresses peeling from a lead frame even when the curing agent is subjected to moisture absorption under conditions of 85° C. and 85% RH. The reason why the first curable resin composition of the present disclosure exhibits the above-mentioned effects is not clear, but is presumed to be as follows.

When the triphenylmethane type epoxy resin has at least one selected from the group consisting of an alkyl group and an alkoxy group, the monomer becomes bulky and the molecular weight of the monomer increases, which results in a polymer with a widened intermolecular distance and low crosslink density after polymerization. Therefore, there are fewer molecules per unit volume and the molecules are more likely to dissolve when tensile stress is applied, which is expected to result in a decrease in the elastic modulus and an increase in the linear expansion coefficient of the cured product of the curable resin composition. As a result, the stress (a combination of distortion, elastic modulus, linear expansion difference, and temperature difference) caused by the linear expansion difference between the support members is reduced and can be lowered to or below the adhesive force of the resin, so that the cured product of the curable resin composition is suppressed from peeling off from the support member. Thus, it is assumed that the reflow resistance also improves.

The second curable resin composition of the present disclosure includes a triphenylmethane type epoxy resin having at least one selected from the group consisting of an alkyl group and an alkoxy group, and a polysiloxane-based stress reliever.

The second curable resin composition of the present disclosure suppresses peeling from a lead frame even when the curing agent is subjected to moisture absorption under conditions of 85° C. and 85% RH. The reason why the second curable resin composition of the present disclosure exhibits the above-mentioned effects is not clear, but is presumed to be as follows.

The expected effects in the case where the specific triphenylmethane type epoxy resin is used are as described in regard to the first curable resin composition. Furthermore, by including a polysiloxane-based stress reliever, it is possible to reduce the occurrence of warping deformation and cracks when the curable resin composition is made into a cured product, and the cured product is effectively suppressed from peeling off from the support member.

The third curable resin composition of the present disclosure has an elastic modulus at 260° C. of 400 MPa or less when made into a cured product, a linear expansion coefficient at 180° C. to 200° C. of 32 ppm/° C. or more when made into a cured product, and an adhesive strength of the cured product to Ag (silver) after treatment at 85° C. and 85% RH of 0.45 MPa or more.

The third curable resin composition of the present disclosure suppresses peeling from a lead frame even when the curing agent is subjected to moisture absorption under conditions of 85° C. and 85% RH. The reason why the third curable resin composition of the present disclosure exhibits the above-mentioned effects is not clear, but is presumed to be as follows.

If the curable resin composition has an elastic modulus at 260° C. of 400 MPa or less when made into a cured product, the distortion stress between the lead frame and the cured product during reflow treatment is reduced, and peeling from the lead frame is suppressed.

In addition, it was previously considered that the smaller the linear expansion coefficient, the more likely it was to suppress peeling from the lead frame. However, it has been experimentally found that the third curable resin composition of the present disclosure is effective in suppressing peeling from the lead frame when the linear expansion coefficient of the cured product at 180° C. to 200° C. is 32 ppm/° C. or more.

Furthermore, by setting the elastic modulus and linear expansion coefficient within the above ranges and setting the adhesive strength of the cured product to Ag (silver) after treatment at 85° C. and 85% RH to 0.45 MPa or more, peeling from the lead frame is suppressed even when the cured product is subjected to moisture absorption under conditions of 85° C. and 85% RH.

The elastic modulus at 260° C. of the cured product of the third curable resin composition is 400 MPa or less, preferably 390 MPa or less, and more preferably 380 MPa or less.

Furthermore, from the viewpoint of protecting the chip from external force, the elastic modulus at 260° C. is preferably 80 MPa or more, more preferably 100 MPa or more, even more preferably 120 MPa or more, and particularly preferably 170 MPa or more.

The elastic modulus of the cured product of the curable resin composition is measured using a viscoelasticity measuring device (for example, RSAIII, manufactured by TA Instruments) under conditions of a span distance of 40 mm and a frequency of 1 Hz by a three-point bending method in which the temperature is raised from 20° C. to 300° C. at 5° C./min to calculate the elastic modulus at 260° C. The cured product is prepared by the method described in regard to the linear expansion coefficient. The cured product used has a rectangular shape with a short side of 5.1 mm, a long side of 20 mm, and a thickness of 2 mm.

The linear expansion coefficient at 180° C. to 200° C. of the cured product of the third curable resin composition is 32 ppm/° C. or more, preferably 34 ppm/° C. or more, and more preferably 36 ppm/° C. or more. From the viewpoint of bringing the linear expansion coefficient close to the linear expansion coefficients of other components used together with the cured product, the upper limit of the linear expansion coefficient is preferably 60 ppm/° C. or less, more preferably 55 ppm/° C. or less, even more preferably 50 ppm/° C. or less, and particularly preferably 42 ppm/° C. or less.

In the present disclosure, the linear expansion coefficient is the slope of the tangent at 180° C. to 200° C. in the case where the distortion of the cured product is plotted against temperature by thermal mechanical analysis (TMA) based on JIS K 7197:2012. The measurement is carried out with a test load of 5 g and a temperature rise rate of 5° C./min. The linear expansion coefficient can be measured using a thermomechanical analyzer (for example, TMA/SS6100 manufactured by Seiko Instruments Inc.).

The cured product is prepared by molding the curable resin composition using a transfer molding machine under conditions of a mold temperature of 175° C., a molding pressure of 6.9 MPa, and a curing time of 90 seconds, and then post-curing under conditions of 175° C. for 5 hours. The cured product has a rectangular shape with a short side of 5.1 mm, a long side of 20 mm, and a thickness of 2 mm.

The adhesive strength to Ag (silver) of the cured product of the third curable resin composition is 0.45 MPa or more, preferably 0.50 MPa or more, and more preferably 0.55 MPa or more. The upper limit of the adhesive strength is not particularly limited.

In the present disclosure, in measuring the adhesive strength of the cured product of the curable resin composition to Ag (silver), a sample is prepared by first applying the curable resin composition onto an Ag substrate, curing the curable resin composition under conditions of 175° C. and a curing time of 120 seconds, and then post-curing under conditions of 175° C. for 5 hours. The cured product of the sample has a shape with a short side of 3.0 mm, a long side of 3.5 mm, and a thickness of 2.9 mm. This sample is heated at 85° C. and 85% RH for 168 hours, and then a shear strength test is performed using a bond tester device (for example, product name 4000 Optima, manufactured by Nordson Corporation) in which the tool of the device is applied to the cured product under conditions of 260° C. to measure the shear strength.

Various materials that may be included in the first to third curable resin compositions will be described hereinafter. The first to third curable resin compositions are collectively referred to as the curable resin composition of the present disclosure.

### (Epoxy Resin)

The first and second curable resin compositions of the present disclosure include the specific triphenylmethane type epoxy resin.

The third curable resin composition preferably includes an epoxy resin. The epoxy resin may be used alone or in combination of two or more. At least one of the epoxy resins is preferably the specific triphenylmethane type epoxy resin.

The specific triphenylmethane type epoxy resin has at least one selected from the group consisting of an alkyl group and an alkoxy group, and preferably has an alkyl group. The specific triphenylmethane type epoxy resin may be used alone or in combination of two or more.

The alkyl group included in the specific triphenylmethane type epoxy resin preferably has 1 to 20 carbon atoms, more preferably 1 to 16 carbon atoms, and even more preferably 1 to 10 carbon atoms. The alkyl group may be linear, branched, or cyclic, but at least one alkyl group is preferably branched and preferably includes a t-butyl group.

The alkoxy group included in the specific triphenylmethane type epoxy resin preferably has 1 to 20 carbon atoms, more preferably 1 to 16 carbon atoms, and even more preferably 1 to 10 carbon atoms. The alkoxy group may be linear, branched, or cyclic.

A benzene ring included in the specific triphenylmethane type epoxy resin preferably has two or more alkyl groups, and it is even more preferable that a benzene ring included in the main chain has two or more alkyl groups. At least one of the two or more alkyl groups of the benzene ring is preferably a branched alkyl group, and the branched alkyl group is preferably located at the ortho position relative to the glycidyloxy group.

The specific triphenylmethane type epoxy resin may be an epoxy resin represented by the following formula (1).

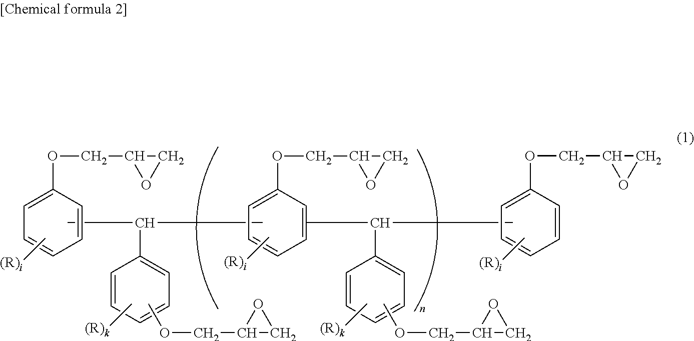

In formula (1), each R independently represents an alkyl group or an alkoxy group, each i independently represents an integer of 1 to 3, and each k independently represents an integer of 0 to 4. n is an average value and represents a number of 0 to 10.

Examples of the alkyl group and alkoxy group represented by R include those described above.

i represents an integer of 1 to 3, preferably 2 or 3, and more preferably 2. In the case where i is 2, at least one of R represented by the subscript i is preferably a branched alkyl group, and more preferably a combination of a branched alkyl group and a linear alkyl group, an example of which is a combination of a t-butyl group and a methyl group. The t-butyl group and the methyl group may be located at any position on the benzene ring, but the t-butyl group is preferably located at the ortho position relative to the glycidyloxy group. Further, the t-butyl group and the methyl group may be in any positional relationship, and may be located at any of the ortho, meta and para positions.

Each k independently represents an integer of 0 to 4, and is preferably 0.

A specific example of the specific triphenylmethane type epoxy resin is an epoxy resin represented by the following formula (2). In formula (2), t-Bu represents a t-butyl group.

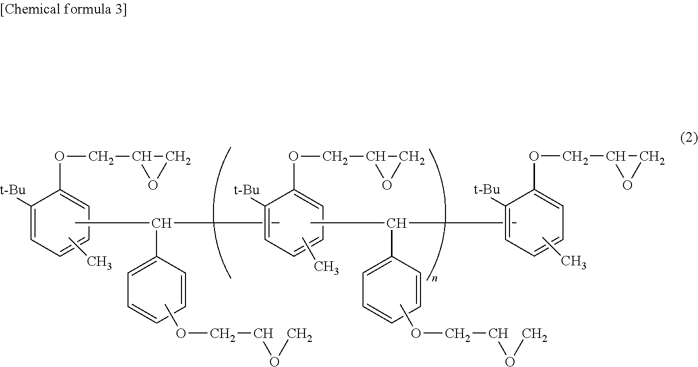

n is an average value and represents a number of 0 to 10.

The curable resin composition of the present disclosure may include other epoxy resins in addition to the specific triphenylmethane type epoxy resin.

The other epoxy resins are not particularly limited in type so long as the other epoxy resins have two or more epoxy groups in one molecule. Specific examples of the other epoxy resins are described below, but are not limited to these.

Specific examples include a novolac type epoxy resin (a phenol novolac type epoxy resin, an orthocresol novolac type epoxy resin, etc.) which is obtained by epoxidizing a novolac resin obtained by condensing or co-condensing at least one phenolic compound selected from the group consisting of phenol compounds such as phenol, cresol, xylenol, resorcin, catechol, bisphenol A, and bisphenol F, and naphthol compounds α-naphthol, β-naphthol, and dihydroxynaphthalene, with an aliphatic aldehyde compound such as formaldehyde, acetaldehyde, and propionaldehyde under an acidic catalyst; a triphenylmethane type epoxy resin which is obtained by epoxidizing a triphenylmethane type phenol resin obtained by condensing or co-condensing the phenolic compound with an aromatic aldehyde compound such as benzaldehyde and salicylaldehyde under an acidic catalyst (however, the specific triphenylmethane type epoxy resin is excluded); a copolymerized epoxy resin which is obtained by epoxidizing a novolac resin obtained by co-condensing the phenol compound and naphthol compound with an aldehyde compound under an acidic catalyst; a diphenylmethane type epoxy resin which is a diglycidyl ether of bisphenol A, bisphenol F, etc.; a biphenyl type epoxy resin which is a diglycidyl ether of alkyl-substituted or unsubstituted biphenol; a stilbene type epoxy resin which is a diglycidyl ether of a stilbene-based phenol compound; a sulfur atom-containing epoxy resin which is a diglycidyl ether of bisphenol S, etc.; an epoxy resin which is a glycidyl ether of alcohols such as butanediol, polyethylene glycol, and polypropylene glycol; a glycidyl ester type epoxy resin which is a glycidyl ester of a polycarboxylic acid compound such as phthalic acid, isophthalic acid, and tetrahydrophthalic acid; a glycidylamine type epoxy resin in which active hydrogen bonded to nitrogen atoms of aniline, diaminodiphenylmethane, isocyanuric acid, etc. is substituted with a glycidyl group; a dicyclopentadiene type epoxy resin which is obtained by epoxidizing a co-condensation resin of dicyclopentadiene and a phenol compound; an alicyclic epoxy resin such as vinylcyclohexene diepoxide, 3,4-epoxycyclohexylmethyl-3,4-epoxycyclohexanecarboxylate, and 2-(3,4-epoxy)cyclohexyl-5,5-spiro(3,4-epoxy)cyclohexane-m-dioxane, which is obtained by epoxidizing an olefin bond in the molecule; a paraxylylene-modified epoxy resin which is a glycidyl ether of a paraxylylene-modified phenol resin; a metaxylylene-modified epoxy resin which is a glycidyl ether of a metaxylylene-modified phenol resin; a terpene-modified epoxy resin which is a glycidyl ether of a terpene-modified phenol resin; a dicyclopentadiene-modified epoxy resin which is a glycidyl ether of a dicyclopentadiene-modified phenol resin; a cyclopentadiene-modified epoxy resin which is a glycidyl ether of a cyclopentadiene-modified phenol resin; a polycyclic aromatic ring-modified epoxy resin which is a glycidyl ether of a polycyclic aromatic ring-modified phenol resin; a naphthalene type epoxy resin which is a glycidyl ether of a naphthalene ring-containing phenol resin; a halogenated phenol novolac type epoxy resin; a hydroquinone type epoxy resin; a trimethylolpropane type epoxy resin; a linear aliphatic epoxy resin which is obtained by oxidizing an olefin bond with a peracid such as peracetic acid; an aralkyl type epoxy resin which is obtained by epoxidizing an aralkyl type phenol resin such as a phenol aralkyl resin and a naphthol aralkyl resin; etc. Further examples of the epoxy resins include aminophenol type epoxy resins which are glycidyl ethers of aminophenol. These epoxy resins may be used alone or in combination of two or more.

Among the above epoxy resins, from the viewpoint of adhesion of the curable resin composition of the present disclosure to a lead frame and a balance between heat resistance and fluidity, it is preferable to include a biphenyl type epoxy resin.

The biphenyl type epoxy resin is not particularly limited as long as the biphenyl type epoxy resin is an epoxy resin having a biphenyl skeleton. For example, an epoxy resin represented by the following general formula (II) is preferable.

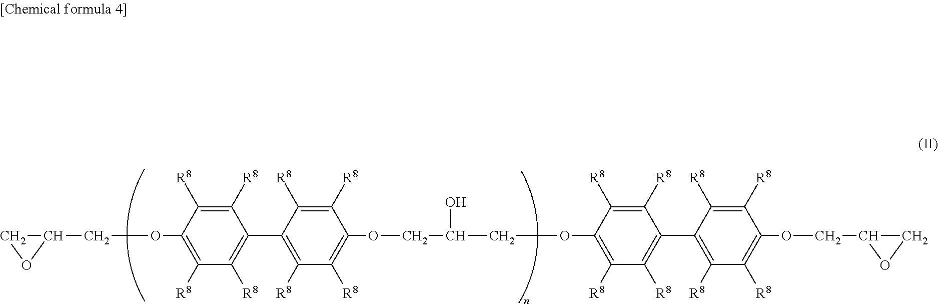

In formula (II), R⁸ represents a hydrogen atom, an alkyl group having 1 to 12 carbon atoms, or an aromatic group having 4 to 18 carbon atoms, and each may be the same or different. n is an average value and represents a number of 0 to 10.

The stilbene type epoxy resin is not particularly limited as long as the stilbene type epoxy resin is an epoxy resin having a stilbene skeleton. For example, an epoxy resin represented by the following general formula (III) is preferable.

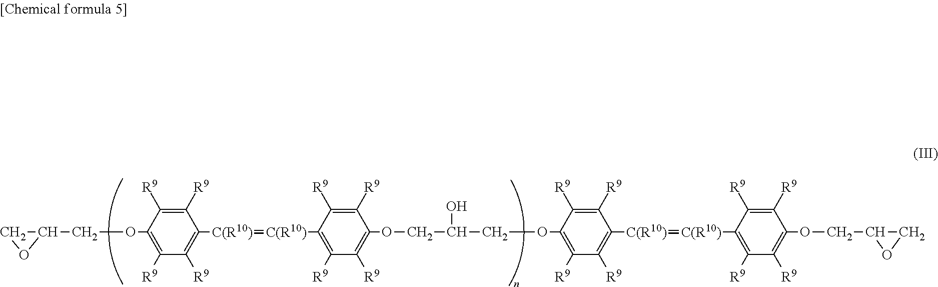

In formula (III), R⁹ and R¹⁰ each represent a hydrogen atom or a monovalent organic group having 1 to 18 carbon atoms, and each may be the same or different. n is an average value and represents a number of 0 to 10.

The diphenylmethane type epoxy resin is not particularly limited as long as the diphenylmethane type epoxy resin is an epoxy resin having a diphenylmethane skeleton. For example, an epoxy resin represented by the following general formula (IV) is preferable.

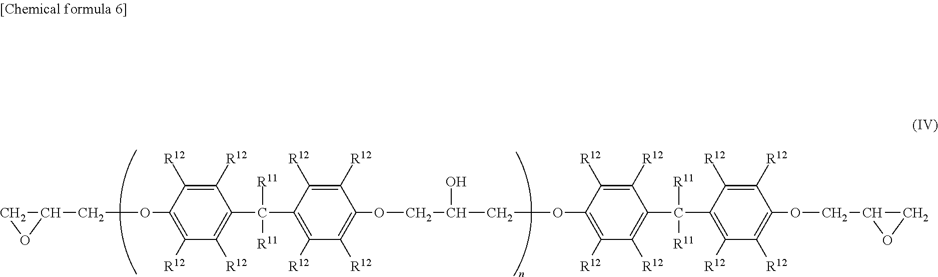

In formula (IV), R¹¹ and R¹² each represent a hydrogen atom or a monovalent organic group having 1 to 18 carbon atoms, and each may be the same or different. n is an average value and represents a number of 0 to 10.

The sulfur atom-containing epoxy resin is not particularly limited as long as the sulfur atom-containing epoxy resin is an epoxy resin containing a sulfur atom. For example, an epoxy resin represented by the following general formula (V) can be mentioned.

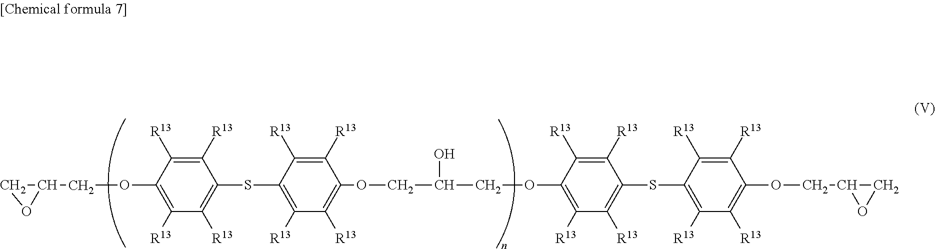

In formula (V), R¹³ represents a hydrogen atom or a monovalent organic group having 1 to 18 carbon atoms, and each may be the same or different. n is an average value and represents a number of 0 to 10.

The novolac type epoxy resin is not particularly limited as long as the novolac type epoxy resin is an epoxy resin obtained by epoxidizing a novolac type phenol resin. For example, an epoxy resin represented by the following general formula (VI) can be mentioned.

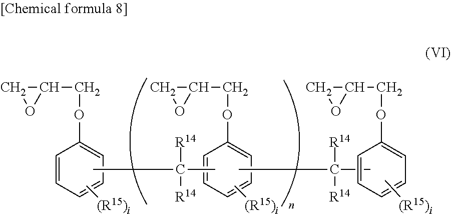

In formula (VI), R¹⁴ represents a hydrogen atom or a monovalent organic group having 1 to 18 carbon atoms, and each may be the same or different. R¹⁵ represents a monovalent organic group having 1 to 18 carbon atoms, and each may be the same or different. Each i independently represents an integer of 0 to 3. n is an average value and represents a number of 0 to 10.

The dicyclopentadiene type epoxy resin is not particularly limited as long as the dicyclopentadiene type epoxy resin is an epoxy resin obtained by epoxidizing a compound having a dicyclopentadiene skeleton as a raw material. For example, an epoxy resin represented by the following general formula (VII) can be mentioned.

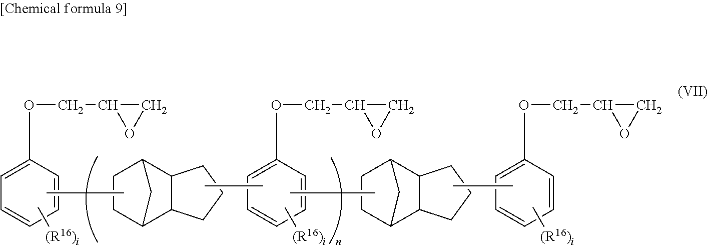

In formula (VII), R¹⁶ represents a monovalent organic group having 1 to 18 carbon atoms, and each may be the same or different. Each i independently represents an integer of 0 to 3. n is an average value and represents a number of 0 to 10.

Examples of triphenylmethane type epoxy resins other than the specific triphenylmethane type epoxy resin include triphenylmethane type epoxy resins having no alkyl group or alkoxy group.

The copolymerized epoxy resin which is obtained by epoxidizing a novolac resin obtained from a naphthol compound and a phenol compound, and an aldehyde compound is not particularly limited as long as the copolymerized epoxy resin is an epoxy resin using a compound having a naphthol skeleton and a compound having a phenol skeleton as raw materials. For example, an epoxy resin represented by the following general formula (IX) can be mentioned.

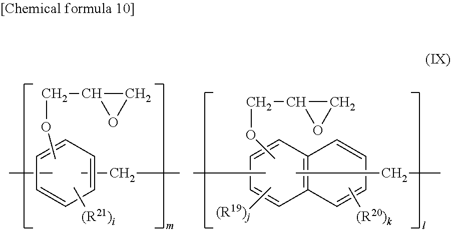

In formula (IX), R¹⁹ to R²¹ each represent a monovalent organic group having 1 to 18 carbon atoms, and each may be the same or different. Each i is independently an integer of 0 to 3; each j is independently an integer of 0 to 2; and each k is independently an integer of 0 to 4. Each of 1 and m is an average value and a number of 0 to 10, and (1+m) is a number of 0 to 10. The terminal of the epoxy resin represented by formula (IX) is either one of the following formula (IX-1) or (IX-2). In formulas (IX-1) and (IX-2), the definitions of R¹⁹ to R²¹, i, j, and k are the same as the definitions of R¹⁹ to R²¹, i, j, and k in formula (IX). n is 1 (in the case of bonding via a methylene group) or 0 (in the case of bonding via a methylene group).

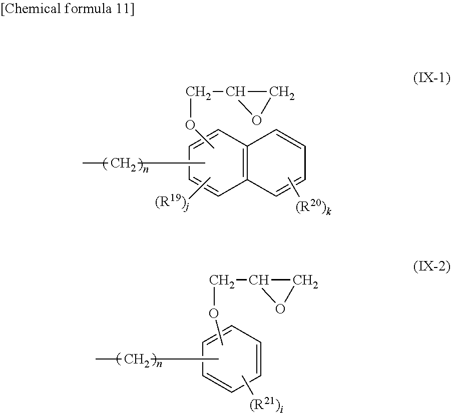

Examples of the epoxy resin represented by the above general formula (IX) include a random copolymer including 1 structural units and m structural units randomly, an alternating copolymer including these alternately, a copolymer including these regularly, a block copolymer including these in a block form, etc. Any one of these may be used alone or in combination of two or more.

As the copolymerized epoxy resin, Epiclon HP-5000 (DIC Corporation, product name), which is a methoxynaphthalene-cresol formaldehyde co-condensed epoxy resin including the following two structural units in a random, alternating, or block order, is also preferable. For example, the epoxy resin may be represented by the following general formula. In the following general formula, n and m each represent an average value and a number of 0 to 10, and (n+m) represents a number of 0 to 10, and preferably n and m each represent an average value and a number of 1 to 9, and (n+m) represents a number of 2 to 10.

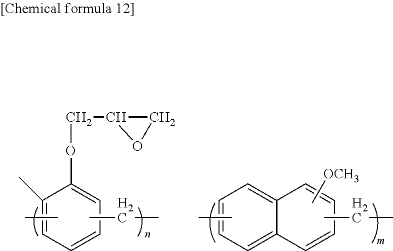

The aralkyl type epoxy resin is not particularly limited as long as the aralkyl type epoxy resin is an epoxy resin using a phenol resin synthesized from at least one selected from the group consisting of phenol compounds such as phenol and cresol, and naphthol compounds such as naphthol and dimethylnaphthol, and dimethoxy-para-xylene, bis(methoxymethyl)biphenyl, or derivatives thereof, as a raw material. For example, an epoxy resin obtained by glycidyl etherifying a phenol resin synthesized from at least one selected from the group consisting of phenol compounds such as phenol and cresol, and naphthol compounds such as naphthol and dimethylnaphthol, and dimethoxy-para-xylene, bis(methoxymethyl)biphenyl, or derivatives thereof is preferable, and epoxy resins represented by the following general formulas (X) and (XI) are more preferable.

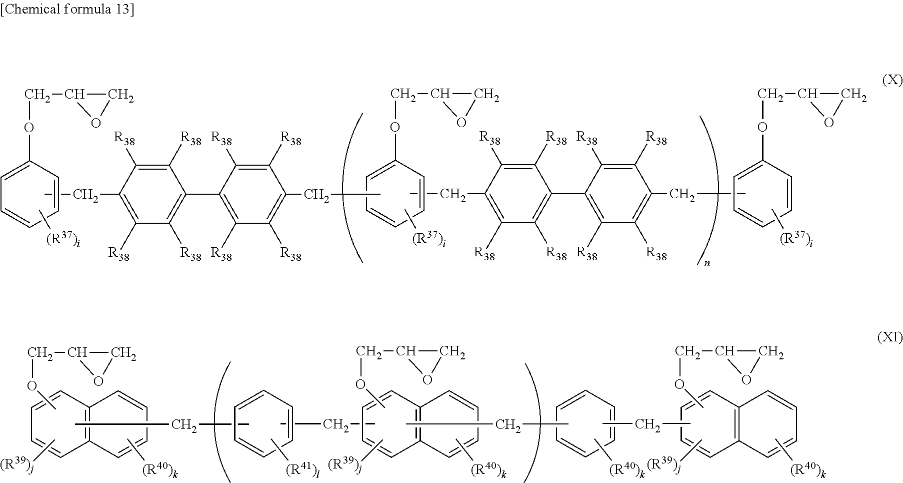

In formulas (X) and (XI), R³⁸ represents a hydrogen atom or a monovalent organic group having 1 to 18 carbon atoms, and each may be the same or different. R³⁷ and R³⁹ to R⁴¹ each represent a monovalent organic group having 1 to 18 carbon atoms, and each may be the same or different. Each i is independently an integer of 0 to 3; each j is independently an integer of 0 to 2; each k is independently an integer of 0 to 4; and each l is independently an integer of 0 to 4. n is an average value and is independently a number of 0 to 10.

With respect to R⁸ to R²¹ and R³⁷ to R⁴¹ in the above general formulas (II) to (VII) and (IX) to (XI), “each may be the same or different” means, for example, that all of the 8 to 88 R⁸ in formula (II) may be the same or different. As for the other R⁹ to R²¹ and R³⁷ to R⁴¹, the respective numbers thereof included in the formula may all be the same or different. Furthermore, R⁸ to R²¹ and R³⁷ to R⁴¹ may be the same or different. For example, all of R⁹ and R¹⁰ may be the same or different.

In addition, the monovalent organic group having 1 to 18 carbon atoms in the general formulas (III) to (VII) and (IX) to (XI) is preferably an alkyl group or an aryl group.

In the above general formulas (II) to (VII) and (IX) to (XI), n is an average value, and each n is preferably in the range of 0 to 10 independently. When n is 10 or less, the melt viscosity of the resin component does not become too high, the viscosity of the curable resin composition during melt molding decreases, and the occurrence of filling defects, deformation of bonding wires (gold wires connecting elements and leads), or the like tends to be suppressed. n is more preferably set in the range of 0 to 4.

The epoxy equivalent of the other epoxy resins is not particularly limited. From the viewpoint of achieving a balance among various characteristics such as moldability, heat resistance, and electrical reliability, the epoxy equivalent of the other epoxy resins is preferably 40 g/eq to 1,000 g/eq, more preferably 45 g/eq to 500 g/eq, and even more preferably 50 g/eq to 350 g/eq.

The epoxy equivalent of the other epoxy resins is a value measured by a method in accordance with JIS K 7236:2009.

The other epoxy resins may be solid or liquid at 25° C. In the case where the epoxy resin is a solid at 25° C., the softening point or melting point of the epoxy resin is not particularly limited. From the viewpoint of a balance between moldability and heat resistance, the softening point or melting point of the other epoxy resins is preferably 40° C. to 180° C. In addition, from the viewpoint of handleability during production of the curable resin composition, the softening point or melting point of the epoxy resin is preferably 50° C. to 130° C.

In the present disclosure, the softening point refers to a value measured by the ring and ball method of JIS K 7234:1986.

In the present disclosure, the melting point refers to a value measured in accordance with the visual observation method of JIS K 0064:1992.

From the viewpoint of a balance between moldability and heat resistance, Mw of the other epoxy resins is preferably 550 to 1,050, and more preferably 650 to 950.

The proportion of the specific triphenylmethane type epoxy resin relative to 100 parts by mass of the total amount of the epoxy resin in the curable resin composition is preferably 15 parts by mass or more, more preferably 20 parts by mass or more, and even more preferably 25 parts by mass or more. The upper limit of this proportion is not particularly limited, but may be 95 parts by mass or less, 90 parts by mass or less, or 85 parts by mass or less.

The total content of the epoxy resin in the curable resin composition is preferably 0.5% by mass to 60% by mass, more preferably 2% by mass to 50% by mass, and even more preferably 3% by mass to 45% by mass, from the viewpoints of strength, fluidity, heat resistance, and moldability.

(Curing Agent) The curable resin composition of the present disclosure preferably includes a curing agent. The type of the curing agent is not particularly limited, and can be selected from curing agents generally used as components of a curable resin composition. The curing agent may be used alone or in combination of two or more.

In the present disclosure, the curing agent has a structure that can react with the epoxy resin included in the curable resin composition to cure the curable resin composition, and even a compound that is contained in a small amount and contributes little to the curing reaction of the curable resin composition is considered to be included in the curing agent.

Examples of the curing agent include a phenol-based curing agent, an amine-based curing agent, an acid anhydride-based curing agent, a polymercaptan-based curing agent, a polyaminoamide-based curing agent, an isocyanate-based curing agent, and a blocked isocyanate-based curing agent.

Among these, the curing agent is preferably a phenol-based curing agent or an amine-based curing agent from the viewpoint of heat resistance. In addition, from the viewpoints of adhesion to a lead frame and heat resistance of the curable resin composition of the present disclosure, the curing agent is preferably a phenol-based curing agent.

Examples of the phenol-based curing agent include phenol resins and polyhydric phenol compounds having two or more phenolic hydroxyl groups in one molecule. Specific examples include a polyhydric phenol compound such as resorcin, catechol, bisphenol A, bisphenol F, and substituted or unsubstituted biphenol; a novolac type phenol resin which is obtained by condensing or co-condensing at least one phenolic compound selected from the group consisting of phenol compounds such as phenol, cresol, xylenol, resorcin, catechol, bisphenol A, bisphenol F, phenylphenol, and aminophenol, and naphthol compounds such as α-naphthol, β-naphthol, and dihydroxynaphthalene, with an aldehyde compound such as formaldehyde, acetaldehyde, and propionaldehyde under an acidic catalyst; an aralkyl type phenol resin such as a phenol aralkyl resin and a naphthol aralkyl resin synthesized from the phenolic compound and dimethoxy-para-xylene, bis(methoxymethyl)biphenyl, etc.; a paraxylylene and/or metaxylylene-modified phenol resin; a melamine-modified phenol resin; a terpene-modified phenol resin; a dicyclopentadiene type phenol resin and a dicyclopentadiene type naphthol resin synthesized by copolymerization of the phenolic compound with dicyclopentadiene; a cyclopentadiene-modified phenol resin; a polycyclic aromatic ring-modified phenol resin; a biphenyl type phenol resin; a triphenylmethane type phenol resin which is obtained by condensing or co-condensing the phenolic compound with an aromatic aldehyde compound such as benzaldehyde and salicylaldehyde under an acidic catalyst; and a phenol resin which is obtained by copolymerizing two or more of these. These phenol-based curing agents may be used alone or in combination of two or more.

Examples of the aralkyl type phenol resin include a phenol aralkyl resin, a naphthol aralkyl resin, etc. synthesized from the phenolic compound and dimethoxy-para-xylene, bis(methoxymethyl)biphenyl, etc. The aralkyl type phenol resin may be further copolymerized with other phenol resins. Examples of the copolymerized aralkyl type phenol resin include a copolymerized phenol resin of a triphenylmethane type phenol resin and an aralkyl type phenol resin, a copolymerized phenol resin of a salicylaldehyde type phenol resin and an aralkyl type phenol resin, a copolymerized phenol resin of a novolac type phenol resin and an aralkyl type phenol resin, etc.

The aralkyl type phenol resin is not particularly limited as long as the aralkyl type phenol resin is a phenol resin synthesized from at least one selected from the group consisting of a phenol compound and a naphthol compound, and dimethoxy-para-xylene, bis(methoxymethyl)biphenyl, or derivatives thereof. For example, phenol resins represented by the following general formulas (XII) to (XIV) are preferable.

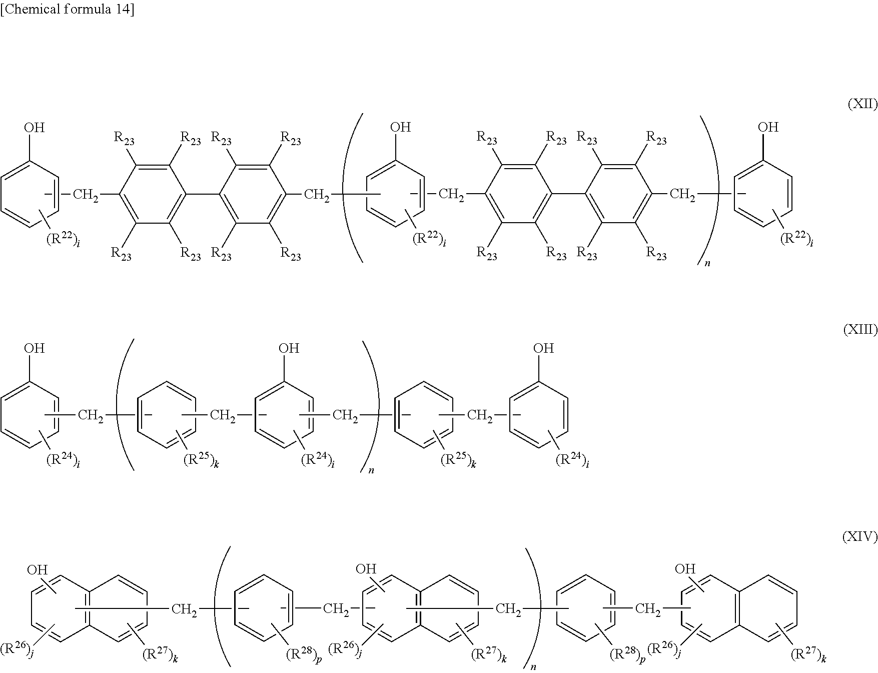

In formulas (XII) to (XIV), R²³ represents a hydrogen atom or a monovalent organic group having 1 to 18 carbon atoms, and each may be the same or different. R²², R²⁴, R²⁵, and R²⁸ each represent a monovalent organic group having 1 to 18 carbon atoms, and each may be the same or different. R²⁶ and R²⁷ each represent a hydroxyl group or a monovalent organic group having 1 to 18 carbon atoms, and each may be the same or different. Each i is independently an integer of 0 to 3; each j is independently an integer of 0 to 2; each k is independently an integer of 0 to 4; and each p is independently an integer of 0 to 4. n is an average value and is independently a number of 0 to 10.

From the viewpoint of adhesion to a lead frame and heat resistance of the curable resin composition of the present disclosure, the aralkyl type phenol resin is preferably a phenol resin represented by general formula (XIII).

From the viewpoint of adhesion to a lead frame and heat resistance of the curable resin composition of the present disclosure, preferably i and k in general formula (XIII) are both 0.

The dicyclopentadiene type phenol resin is not particularly limited as long as the dicyclopentadiene type phenol resin is a phenol resin obtained from a compound having a dicyclopentadiene skeleton as a raw material. For example, a phenol resin represented by the following general formula (XV) can be mentioned.

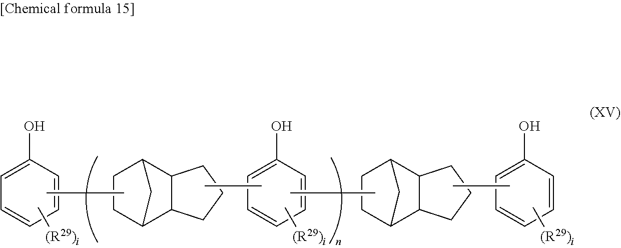

In formula (XV), R²⁹ represents a monovalent organic group having 1 to 18 carbon atoms, and each may be the same or different. Each i independently represents an integer of 0 to 3. n is an average value and represents a number of 0 to 10.

The triphenylmethane type phenol resin is not particularly limited as long as the triphenylmethane type phenol resin is a phenol resin obtained from an aromatic aldehyde compound as a raw material. For example, a phenol resin represented by the following general formula (XVI) is preferable.

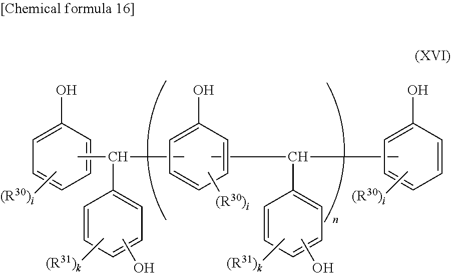

In formula (XVI), R³⁰ and R³¹ each represent a monovalent organic group having 1 to 18 carbon atoms, and each may be the same or different. Each i is independently an integer of 0 to 3; and each k is independently an integer of 0 to 4. n is an average value and is a number of 0 to 10.

The copolymerized phenol resin of a triphenylmethane type phenol resin and an aralkyl type phenol resin is not particularly limited as long as the copolymerized phenol resin is a copolymerized phenol resin of a phenol resin obtained from a compound having a benzaldehyde skeleton as a raw material and an aralkyl type phenol resin. For example, a phenol resin represented by the following general formula (XVII) is preferable.

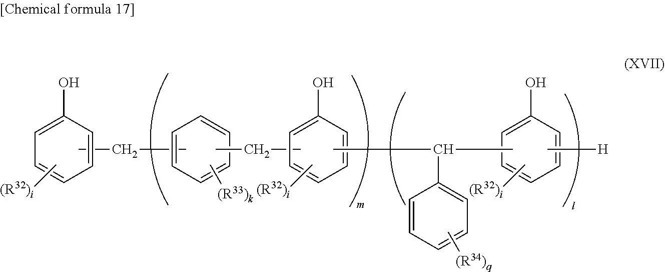

In formula (XVII), R³² to R³⁴ each represent a monovalent organic group having 1 to 18 carbon atoms, and each may be the same or different. Each i is independently an integer of 0 to 3; each k is independently an integer of 0 to 4; and each q is independently an integer of 0 to 5. 1 and m each represent an average value and are independently a number of 1 to 11.

The novolac type phenol resin is not particularly limited as long as the novolac type phenol resin is a phenol resin obtained by condensing or co-condensing at least one phenolic compound selected from the group consisting of phenol compounds and naphthol compounds with an aldehyde compound under an acidic catalyst. For example, a phenol resin represented by the following general formula (XVIII) is preferable.

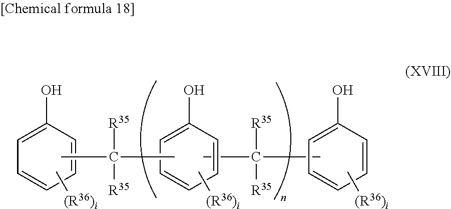

In formula (XVIII), R³⁵ represents a hydrogen atom or a monovalent organic group having 1 to 18 carbon atoms, and each may be the same or different. R³⁶ represents a monovalent organic group having 1 to 18 carbon atoms, and each may be the same or different. Each i independently represents an integer of 0 to 3. n is an average value and represents a number of 0 to 10.

The “each may be the same or different” described with respect to R²² to R³⁶ in the above general formulas (XII) to (XVIII) means, for example, that all of the i R²² in formula (XII) may be the same or different from each other. As for the other R²³ to R³⁶, the respective numbers thereof included in the formula may all be the same or different from each other. Furthermore, R²² to R³⁶ may be the same or different. For example, all of R²² and R²³ may be the same or different, and all of R³⁰ and R³¹ may be the same or different.

In the above general formulas (XII) to (XVIII), n is preferably in the range of 0 to 10. When n is 10 or less, the melt viscosity of the resin component does not become too high, the viscosity of the curable resin composition during melt molding also decreases, and it is difficult for filling defects, deformation of bonding wires (gold wires connecting elements and leads), or the like to occur. The average n in one molecule is preferably set in the range of 0 to 4.

Specific examples of the amine-based curing agent include aliphatic amine compounds such as diethylenetriamine, triethylenetetramine, n-propylamine, 2-hydroxyethylaminopropylamine, cyclohexylamine, and 4,4′-diamino-dicyclohexylmethane; aromatic amine compounds such as diethyltoluenediamine, 3,3′-diethyl-4,4′-diaminodiphenylmethane, dimethylthiotoluenediamine, and 2-methylaniline; imidazole compounds such as imidazole, 2-methylimidazole, 2-ethylimidazole, and 2-isopropylimidazole; imidazoline compounds such as imidazoline, 2-methylimidazoline, and 2-ethylimidazoline; etc.

The functional group equivalent of the curing agent (hydroxyl group equivalent in the case of a phenol-based curing agent, active hydrogen equivalent in the case of an amine-based curing agent) is not particularly limited. From the viewpoint of achieving a balance among various characteristics such as moldability, heat resistance, and electrical reliability, the functional group equivalent is preferably 10 g/eq to 1,000 g/eq, and more preferably 30 g/eq to 500 g/eq.

In the case of a phenol-based curing agent, the hydroxyl group equivalent refers to a value calculated based on the hydroxyl value measured in accordance with JIS K 0070:1992. Further, in the case of an amine-based curing agent, the active hydrogen equivalent refers to a value calculated based on the amine value measured in accordance with JIS K 7237:1995.

In the case where the curing agent is a solid at 25° C., the softening point or melting point thereof is not particularly limited. From the viewpoints of moldability and heat resistance, the softening point or melting point of the curing agent is preferably 40° C. to 180° C. In addition, from the viewpoint of handleability during production of the curable resin composition, the softening point or melting point of the curing agent is preferably 50° C. to 130° C.

In the case where the curing agent is a phenol-based curing agent, the equivalent ratio of the phenolic hydroxyl group (active hydrogen) of the phenol-based curing agent to the epoxy group of the epoxy resin in the curable resin composition (the number of moles of the phenolic hydroxyl group (active hydrogen) of the phenol-based curing agent/the number of moles of the epoxy group of the epoxy resin) is not particularly limited, and can be, for example, 0.5 to 1.2, 0.5 to 1.0, 0.55 to 0.9, or 0.6 to 0.8.

When the equivalent ratio is 0.5 or more and less than 1.0, the adhesion between the cured product of the curable resin composition and the support member tends to be improved. The reason for this is not clear, but it is possible to increase the value of tan δ near the reflow temperature, which tends to reduce the internal stress of the resin cured product during reflow.

In the case where the curing agent includes a phenol-based curing agent, from the viewpoint of adhesion of the curable resin composition of the present disclosure to a lead frame, the content of the phenol-based curing agent relative to the total mass of the curing agent is preferably 50% by mass to 100% by mass, more preferably 60% by mass to 100% by mass, and even more preferably 70% by mass to 100% by mass.

In the case where the phenol-based curing agent includes an aralkyl type phenol resin, from the viewpoint of adhesion of the curable resin composition of the present disclosure to a lead frame, the content of the aralkyl type phenol resin relative to the total mass of the phenol-based curing agent is more preferably 60% by mass to 100% by mass, and even more preferably 70% by mass to 100% by mass.

### (Inorganic Filler)

The curable resin composition of the present disclosure may include an inorganic filler. As the curable resin composition includes an inorganic filler, the moisture absorption of the curable resin composition tends to be reduced, and the strength in the cured state tends to be improved. In the case where the curable resin composition is used as a sealing material for a semiconductor package, it is preferable to include an inorganic filler.

The inorganic material constituting the inorganic filler is not particularly limited. Specific examples of the inorganic material include spherical silica, crystalline silica, glass, alumina, calcium carbonate, zirconium silicate, calcium silicate, silicon nitride, aluminum nitride, boron nitride, aluminum nitride, boehmite, beryllia, magnesium oxide, zirconia, zircon, forsterite, steatite, spinel, mullite, titania, talc, clay, mica, titanate, etc.

An inorganic filler made of an inorganic material having a flame retardant effect may be used. Examples of the inorganic material having a flame retardant effect include aluminum hydroxide, magnesium hydroxide, composite metal hydroxide such as composite hydroxide of magnesium and zinc, zinc borate, etc.

The inorganic filler may be used alone or in combination of two or more.

The shape of the inorganic filler is not particularly limited, and examples thereof include powder, spheres, fibers, etc. From the viewpoints of fluidity and mold wear during molding of the curable resin composition, spheres are preferable.

The average particle size of the inorganic filler is not particularly limited. From the viewpoint of achieving a balance between the viscosity, filling property, etc. of the curable resin composition, the volume average particle size of the inorganic filler is preferably 0.1 μm to 50 μm, more preferably 0.3 μm to 30 μm, and even more preferably 0.5 μm to 25 μm.

The volume average particle size of the inorganic filler can be measured as a volume average particle size (D50) by a laser diffraction scattering particle size distribution measuring device.

The particle size of the inorganic filler may be top cut, may be top cut at 100 μm or less, may be top cut at 75 μm or less, or may be top cut at 53 μm or less.

The top cut particle size can be determined from the particle size distribution when the above volume average particle size (D50) is measured.

In the case where the curable resin composition includes an inorganic filler, the content thereof is not particularly limited. The content of the inorganic filler relative to the entire curable resin composition is preferably 30% by mass to 90% by mass, more preferably 35% by mass to 80% by mass, and even more preferably 40% by mass to 70% by mass.

When the content of the inorganic filler is 30% by mass or more based on the entire curable resin composition, the characteristics of the cured product, such as the thermal expansion coefficient, thermal conductivity, and elastic modulus, tend to be further improved. When the content of the inorganic filler is 90% by mass or less based on the entire curable resin composition, an increase in viscosity of the curable resin composition is suppressed, and the fluidity tends to be further improved to improve moldability.

The content of the inorganic filler relative to the entire curable resin composition is preferably 68% by volume to 86% by volume, more preferably 70% by volume to 84% by volume, and even more preferably 72% by volume to 82% by volume.

When the content of the inorganic filler is 68% by volume or more based on the entire curable resin composition, the characteristics of the cured product, such as the thermal expansion coefficient, thermal conductivity, and elastic modulus, tend to be further improved. When the content of the inorganic filler is 86% by volume or less based on the entire curable resin composition, an increase in viscosity of the curable resin composition is suppressed, and the fluidity tends to be further improved to improve moldability.

### (Curing Accelerator)

The curable resin composition of the present disclosure may include a curing accelerator. The type of the curing accelerator is not particularly limited, and can be selected depending on the type of epoxy resin, the desired characteristics of the curable resin composition, or the like. The curing accelerator may be used alone or in combination of two or more. Specific examples of the curing accelerator are described below, but are not limited to these.

Examples of the curing accelerator include diazabicycloalkenes such as 1,5-diazabicyclo[4.3.0]nonene-5 (DBN) and 1,8-diazabicyclo[5.4.0]undecene-7 (DBU), cyclic amidine compounds such as 2-methylimidazole, 2-phenylimidazole, 2-phenyl-4-methylimidazole, and 2-heptadecylimidazole; derivatives of the cyclic amidine compounds; phenol novolac salts of the cyclic amidine compounds or derivatives thereof; compounds having intramolecular polarization obtained by adding compounds having a x bond, such as quinone compounds such as maleic anhydride, 1,4-benzoquinone, 2,5-toluquinone, 1,4-naphthoquinone, 2,3-dimethylbenzoquinone, 2,6-dimethylbenzoquinone, 2,3-dimethoxy-5-methyl-1,4-benzoquinone, 2,3-dimethoxy-1,4-benzoquinone, and phenyl-1,4-benzoquinone, and diazophenylmethane, to these compounds; cyclic amidinium compounds such as tetraphenylborate salt of DBU, tetraphenylborate salt of DBN, tetraphenylborate salt of 2-ethyl-4-methylimidazole, and tetraphenylborate salt of N-methylmorpholine; tertiary amine compounds such as pyridine, triethylamine, triethylenediamine, benzyldimethylamine, triethanolamine, dimethylaminoethanol, and tris(dimethylaminomethyl) phenol; derivatives of the tertiary amine compounds; ammonium salt compounds such as tetra-n-butylammonium acetate, tetra-n-butylammonium phosphate, tetraethylammonium acetate, tetra-n-hexylammonium benzoate, and tetrapropylammonium hydroxide; organic phosphines such as primary phosphines such as ethylphosphine and phenylphosphine, secondary phosphines such as dimethylphosphine and diphenylphosphine, and tertiary phosphines such as triphenylphosphine, diphenyl(p-tolyl)phosphine, tris(alkylphenyl)phosphine, tris(alkoxyphenyl)phosphine, tris(alkylalkoxyphenyl)phosphine, tris(dialkylphenyl)phosphine, tris(trialkylphenyl)phosphine, tris(tetraalkylphenyl)phosphine, tris(dialkoxyphenyl)phosphine, tris(trialkoxyphenyl)phosphine, tris(tetraalkoxyphenyl)phosphine, trialkylphosphines, dialkylarylphosphines, alkyldiarylphosphines, trinaphthylphosphine, and tris(benzyl)phosphine; phosphine compounds such as complexes of the organic phosphines and organic borons; compounds having intramolecular polarization obtained by adding compounds having a x bond, such as quinone compounds such as maleic anhydride, 1,4-benzoquinone, 2,5-toluquinone, 1,4-naphthoquinone, 2,3-dimethylbenzoquinone, 2,6-dimethylbenzoquinone, 2,3-dimethoxy-5-methyl-1,4-benzoquinone, 2,3-dimethoxy-1,4-benzoquinone, phenyl-1,4-benzoquinone, and anthraquinone, and diazophenylmethane, to the organic phosphines or the phosphine compounds; compounds having intramolecular polarization obtained by reacting the organic phosphines or the phosphine compounds with halogenated phenol compounds such as 4-bromophenol, 3-bromophenol, 2-bromophenol, 4-chlorophenol, 3-chlorophenol, 2-chlorophenol, 4-iodophenol, 3-iodophenol, 2-iodophenol, 4-bromo-2-methylphenol, 4-bromo-3-methylphenol, 4-bromo-2,6-dimethylphenol, 4-bromo-3,5-dimethylphenol, 4-bromo-2,6-di-t-butylphenol, 4-chloro-1-naphthol, 1-bromo-2-naphthol, 6-bromo-2-naphthol, and 4-bromo-4′-hydroxybiphenyl, followed by a dehydrohalogenation step; tetra-substituted phosphonium compounds such as tetraphenylphosphonium, tetraphenylborate salts of tetra-substituted phosphonium such as tetraphenylphosphonium tetra-p-tolylborate, and salts of tetra-substituted phosphonium with phenolic compounds; phosphobetaine compounds; adducts of phosphonium compounds and silane compounds, etc.

In the case where the curable resin composition includes a curing accelerator, the content of the curing accelerator is preferably 0.1% by mass to 8% by mass, more preferably 0.3% by mass to 7% by mass, and even more preferably 0.5% by mass to 6% by mass, relative to 100 parts by mass of the total amount of the epoxy resin and the curing agent. By setting the content of the curing accelerator within the above numerical range, the curing rate of the curable resin composition of the present disclosure becomes an appropriate value, making it easy to produce a molded product.

### (Stress Reliever)

The second curable resin composition of the present disclosure includes a polysiloxane-based stress reliever.

The polysiloxane-based stress reliever may be used alone or in combination of two or more. The polysiloxane-based stress reliever may be in any form at 25° C., such as a solid, a liquid, or rubber particles. Furthermore, the polysiloxane-based stress reliever may include a polymer moiety other than a polysiloxane skeleton, such as a methyl methacrylate-silicone copolymer, so long as the polysiloxane-based stress reliever includes a polysiloxane skeleton.

Examples of the polysiloxane-based stress reliever include stress relievers having a methyl group and a phenyl group, stress relievers having an epoxy group, stress relievers having an amino group, stress relievers modified with polyether, etc.

The polysiloxane-based stress reliever is more preferably a polysiloxane having an epoxy group, a polyether-based polysiloxane, or the like. Among these, a polyether-based polysiloxane is preferable from the viewpoint of preventing peeling of the cured product from a lead frame.

The polyether-based polysiloxane is not particularly limited as long as the polyether-based polysiloxane is a compound in which a polyether group is introduced into silicone, which is a polymeric compound having a main skeleton formed by siloxane bonds.

The polyether-based polysiloxane may be a side-chain-modified polyether-based polysiloxane or a terminal-modified polyether-based polysiloxane. Among these polyether-based polysiloxanes, a side-chain modified polyether-based polysiloxane is preferable from the viewpoint of suppressing defects in the appearance of the cured product.

An example of the polyether-based polysiloxane is an epoxy-polyether-based polysiloxane. The epoxy-polyether-based polysiloxane is not particularly limited as long as the epoxy-polyether-based polysiloxane is a compound in which a polyether group and an epoxy group are introduced into silicone, which is a polymeric compound having a main skeleton formed by siloxane bonds.

The epoxy-polyether-based polysiloxane may be a side-chain-modified epoxy-polyether-based polysiloxane, a terminal-modified epoxy-polyether-based polysiloxane, or a side-chain-and-terminal-modified epoxy-polyether-based polysiloxane. The main skeleton of the epoxy-polyether-based polysiloxane is preferably polydimethylsiloxane. The polyether group is preferably a polyether group in which one or both of ethylene oxide and propylene oxide are polymerized.

The epoxy-polyether-based polysiloxane is preferably a side-chain-modified epoxy-polyether-based polysiloxane in which a polyether group (preferably a polyether group in which one or both of ethylene oxide and propylene oxide are polymerized) and an epoxy group are each present in the side chain of silicone (preferably polydimethylsiloxane).

The polysiloxane-based stress reliever may include a branched polysiloxane having the following structural units (a) and (b), a terminal of which is at least one functional group selected from the group consisting of R¹, a hydroxyl group, and an alkoxy group, and having an epoxy equivalent of 500 g/eq to 4,000 g/eq. Hereinafter, “a branched polysiloxane having the structural units (a) and (b), a terminal of which is at least one functional group selected from the group consisting of R¹, a hydroxyl group, and an alkoxy group, and having an epoxy equivalent of 500 g/eq to 4,000 g/eq” will also be referred to as “specific branched polysiloxane.”

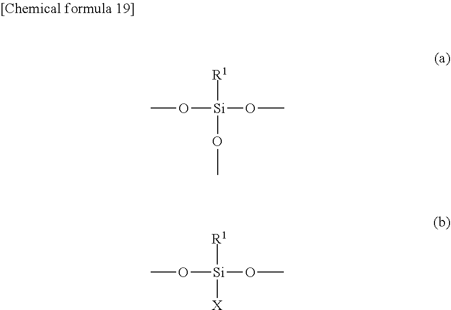

R¹ represents an unsubstituted alkyl group, alkenyl group, aryl group, or aralkyl group having 1 to 12 carbon atoms, and in the case where a plurality of R¹ are present in the branched polysiloxane, the plurality of R¹ may be the same or different. X represents a 2,3-epoxypropyl group, a 3,4-epoxybutyl group, a 4,5-epoxypentyl group, a 2-glycidoxyethyl group, a 3-glycidoxypropyl group, a 4-glycidoxybutyl group, a 2-(3,4-epoxycyclohexyl)ethyl group, or a 3-(3,4-epoxycyclohexyl)propyl group.

R¹ represents an alkyl group, an alkenyl group, an aryl group, or an aralkyl group.

Examples of the alkyl group represented by R¹ include a methyl group, an ethyl group, a propyl group, a butyl group, an isopropyl group, an isobutyl group, a t-butyl group, a pentyl group, a hexyl group, a heptyl group, an octyl group, a 2-ethylhexyl group, etc.

Examples of the alkenyl group represented by R¹ include an alkyl group, a vinyl group, an allyl group, a butenyl group, a pentenyl group, a hexenyl group, etc.

Examples of the aryl group represented by R¹ include a phenyl group, a tolyl group, a xylyl group, a naphthyl group, a biphenyl group, etc.

Examples of the aralkyl group represented by R¹ include a benzyl group, a phenethyl group, etc.

Among these, R¹ is preferably a methyl group or a phenyl group.

X represents a 2,3-epoxypropyl group, a 3,4-epoxybutyl group, a 4,5-epoxypentyl group, a 2-glycidoxyethyl group, a 3-glycidoxypropyl group, a 4-glycidoxybutyl group, a 2-(3,4-epoxycyclohexyl)ethyl group, or a 3-(3,4-epoxycyclohexyl)propyl group, and among these, a 3-glycidoxypropyl group is preferable.

In addition, from the viewpoint of storage stability of the polymer, the terminal of the specific branched polysiloxane is at least one functional group selected from the group consisting of the above-mentioned R¹, a hydroxyl group, and an alkoxy group.

The epoxy equivalent of the specific branched polysiloxane is in the range of 500 g/eq to 4,000 g/eq, and preferably 1,000 g/eq to 2,500 g/eq. When the epoxy equivalent of the specific branched polysiloxane is 500 g/eq or more, the fluidity of the curable resin composition tends to be improved, and when the epoxy equivalent is 4,000 g/eq or less, the exudation to the surface of the cured product is suppressed, and the moldability tends to be excellent.

From the viewpoints of fluidity of the curable resin composition and low warpage when made into a cured product, it is preferable that the specific branched polysiloxane further includes the following structural unit (c).

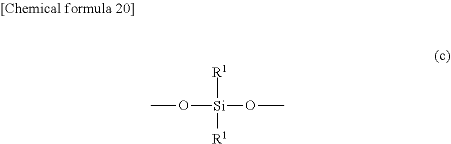

R¹ in the structural unit (c) is selected from a substituted or unsubstituted monovalent hydrocarbon group having 1 to 12 carbon atoms, and a plurality of R¹ may be the same or different. Examples of the hydrocarbon group represented by R¹ in the structural unit (c) include the groups exemplified as R¹ in the structural units (a) and (b).

The specific branched polysiloxane may be a block copolymer or a random copolymer, and is preferably a random copolymer.

The softening point of the specific branched polysiloxane is preferably 40° C. to 120° C., and more preferably 50° C. to 100° C. When the softening point of the specific branched polysiloxane is 40° C. or higher, the mechanical strength of the curable resin composition when made into a cured product tends to be improved, whereas when the softening point is 120° C. or lower, the dispersibility of the specific branched polysiloxane in the curable resin composition tends to be excellent.

Methods for adjusting the softening point of the specific branched polysiloxane include appropriately setting the molecular weight of the specific branched polysiloxane, the content ratio of the structural units (a) to (c), the type of silicon-bonded organic group, or the like. From the viewpoints of dispersibility of the specific branched polysiloxane in the curable resin composition and fluidity of the curable resin composition, it is preferable to adjust the softening point by adjusting the content of the aryl group in the specific branched polysiloxane. In this case, the aryl group includes a phenyl group, a tolyl group, a xylyl group, a naphthyl group, a biphenyl group, etc., and a phenyl group is more preferable. The content of the phenyl group in the monovalent organic group bonded to silicon atoms in the specific branched polysiloxane is preferably 60 mol % to 99 mol %, and more preferably 70 mol % to 85 mol %.

The weight average molecular weight (Mw) of the specific branched polysiloxane is a value measured by gel permeation chromatography (GPC) and converted using a standard polystyrene calibration curve, and is preferably 1,000 to 30,000, more preferably 2,000 to 20,000, and even more preferably 3,000 to 10,000.

The specific branched polysiloxane can be obtained by the production method shown below, or may be available as a commercially available product.

The method for producing the specific branched polysiloxane is not particularly limited, and the specific branched polysiloxane can be produced by a known method. For example, organochlorosilane, organoalkoxysilane, siloxane, or partial hydrolysis condensates thereof capable of forming the above (a) to (c) units by hydrolysis condensation reaction can be mixed in a mixture solution of an organic solvent capable of dissolving the raw materials and the reaction products and an amount of water capable of hydrolyzing all of the hydrolyzable groups in the raw materials, and the resulting mixture solution can be subjected to hydrolysis condensation reaction. In this case, in order to reduce the amount of chlorine contained as an impurity in the curable resin composition, it is preferable to use organoalkoxysilane and/or siloxane as raw materials. In this case, it is preferable to add an acid, a base, or an organometallic compound as a catalyst for accelerating the reaction.

Examples of the organoalkoxysilane and/or siloxane serving as raw materials for the specific branched polysiloxane include methyltrimethoxysilane, methyltriethoxysilane, ethyltrimethoxysilane, ethyltriethoxysilane, vinyltrimethoxysilane, vinyltriethoxysilane, phenyltrimethoxysilane, phenyltriethoxysilane, dimethyldimethoxysilane, methylphenyldimethoxysilane, methylvinyldimethoxysilane, phenylvinyldimethoxysilane, diphenyldimethoxysilane, methylphenyldiethoxysilane, methylvinyldiethoxysilane, phenylvinyldiethoxysilane, diphenyldiethoxysilane, dimethyldiethoxysilane, tetramethoxysilane, tetraethoxysilane, dimethoxydiethoxysilane, 3-glycidoxypropyltrimethoxysilane, 3-glycidoxypropyltriethoxysilane, 3-glycidoxypropyl(methyl)dimethoxysilane, 3-glycidoxypropyl(methyl)diethoxysilane, 3-glycidoxypropyl(phenyl)dimethoxysilane, 3-glycidoxypropyl(phenyl)diethoxysilane, 2-(3,4-epoxycyclohexyl)ethyl(methyl)dimethoxysilane, 2-(3,4-epoxycyclohexyl)ethyl(methyl)diethoxysilane, 2-(3,4-epoxycyclohexyl)ethyl(phenyl)dimethoxysilane, 2-(3,4-epoxycyclohexyl)ethyl(phenyl)diethoxysilane, hydrolysis condensates thereof, etc.

The total content of the polysiloxane-based stress reliever is preferably 3 parts by mass to 50 parts by mass, more preferably 4 parts by mass to 45 parts by mass, and even more preferably 5 parts by mass to 40 parts by mass, relative to 100 parts by mass of the resin component (the total amount of the epoxy resin and the curing agent).

The second curable resin composition of the present disclosure may include stress relievers other than the polysiloxane-based stress reliever. The other stress relievers include thermoplastic elastomers such as styrene-based, olefin-based, urethane-based, polyester-based, polyether-based, polyamide-based, and polybutadiene-based elastomers, natural rubber (NR), acrylonitrile-butadiene copolymer (NBR), acrylic rubber, urethane rubber, methyl methacrylate butadiene styrene copolymer (MBS), methyl methacrylate-butyl acrylate copolymer, triphenylphosphine, coumarone resin, rubber particles having a core-shell structure using these, etc. The other stress relievers may be used alone or in combination of two or more.

The above stress reliever may be a commercially available product or a synthesized product. Examples of the commercially available polysiloxane-based stress reliever and specific branched polysiloxane-based stress reliever include 217Flake, 233Flake, 249Flake, 220Flake, SH6018, AY42-119 (all manufactured by Dow-Toray Industries, Inc.), KR-480 (Shin-Etsu Chemical Co., Ltd.), and SRK-200A (Mitsubishi Chemical Corporation).

Examples of the butadiene-based and acrylic-based stress relievers include U Powder (Unitika Ltd.), CTBN1008SP and CTBN1009SP (UBE Ltd.), JP200 (Nippon Soda Co., Ltd.), and BTA-751 (Dow Chemical Company).

Examples of the polyether-based stress reliever include FZ-3711, FZ-3720, and FZ-3730 (Dow Chemical Company).

The content of the polysiloxane-based stress reliever relative to the total content of the stress relievers is preferably 10% by mass or more, more preferably 15% by mass or more, and even more preferably 20% by mass or more.

The first curable resin composition and the third curable resin composition of the present disclosure may include a stress reliever such as silicone oil and silicone rubber particles. By including the stress reliever in the curable resin composition, the occurrence of package warping deformation and package cracks can be further reduced. The stress reliever may be any known stress reliever (flexibilizer) that is generally used. Specific examples of the stress reliever include thermoplastic elastomers such as silicone-based, styrene-based, olefin-based, urethane-based, polyester-based, polyether-based, polyamide-based, and polybutadiene-based elastomers; rubber particles such as natural rubber (NR), acrylonitrile-butadiene copolymer (NBR), acrylic rubber, urethane rubber, and silicone powder; and rubber particles having a core-shell structure such as methyl methacrylate butadiene styrene copolymer (MBS), methyl methacrylate-silicone copolymer, and methyl methacrylate-butyl acrylate copolymer, etc. The stress reliever may be used alone or in combination of two or more. Among these, a silicone-based stress reliever is preferable. Examples of the silicone-based stress reliever include stress relievers having an epoxy group, stress relievers having an amino group, stress relievers modified with polyether, etc. Examples of the silicone-based stress reliever that can be used in the first curable resin composition and the third curable resin composition include the above-mentioned silicone-based stress reliever included in the second curable resin composition.

In the case where the first curable resin composition and the third curable resin composition each include a stress reliever, the content thereof is preferably 10 parts by mass to 60 parts by mass, and more preferably 20 parts by mass to 50 parts by mass, relative to 100 parts by mass of the epoxy resin included in the curable resin composition.

### (Various Additives)

The curable resin composition of the present disclosure may include, in addition to the above-mentioned components, various additives such as a coupling agent, a release agent, a colorant, a flame retardant, and an ion exchanger. In addition, the curable resin composition of the present disclosure may include a siloxane compound having a structural unit having an epoxy group and an alkoxy group and having a degree of polymerization of 2. The curable resin composition may include various additives well known in the art, as necessary, in addition to the additives exemplified below.

### (Coupling Agent)

The curable resin composition of the present disclosure may include a coupling agent. The type of the coupling agent is not particularly limited, and any known coupling agent can be used. Examples of the coupling agent include a silane coupling agent, a titanium coupling agent, etc. The coupling agent may be used alone or in combination of two or more.

The silane coupling agent is not particularly limited, and examples thereof include 3-glycidoxypropyltrimethoxysilane, 3-glycidoxypropyltriethoxysilane, 3-glycidoxypropylmethyldiethoxysilane, 3-glycidoxypropylmethyldimethoxysilane, 2-(3,4-epoxycyclohexyl)ethyltrimethoxysilane, 3-aminopropyltriethoxysilane, 3-(2-aminoethyl)aminopropyltrimethoxysilane, 3-(2-aminoethyl)aminopropyltriethoxysilane, 3-aminopropyltrimethoxysilane, N-phenyl-3-aminopropyltrimethoxysilane, 3-mercaptopropyltrimethoxysilane, 3-mercaptopropyltriethoxysilane, 3-ureidopropyltriethoxysilane, octenyltrimethoxysilane, glycidoxyoctyltrimethoxysilane, methacryloxyoctyltrimethoxysilane, etc.

Examples of the titanium coupling agent include isopropyl triisostearoyl titanate, isopropyl tris(dioctyl pyrophosphate) titanate, isopropyl tri(N-aminoethyl-aminoethyl) titanate, tetraoctyl bis(ditridecyl phosphite) titanate, tetra(2,2-diallyloxymethyl-1-butyl)bis(ditridecyl phosphite) titanate, bis(dioctyl pyrophosphate)oxyacetate titanate, bis(dioctyl pyrophosphate)ethylene titanate, isopropyl trioctanoyl titanate, isopropyl dimethacryl isostearoyl titanate, isopropyl tridodecyl benzenesulfonyl titanate, isopropyl isostearoyl diacryl titanate, isopropyl tri(dioctyl phosphate) titanate, isopropyl tricumyl phenyl titanate, tetraisopropyl bis(dioctyl phosphite) titanate, etc.

In the case where the curable resin composition includes a coupling agent, the content of the coupling agent is preferably 0.001 parts by mass to 10 parts by mass, more preferably 0.01 parts by mass to 8 parts by mass, and even more preferably 0.05 parts by mass to 5 parts by mass, relative to 100 parts by mass of the inorganic filler included in the curable resin composition, from the viewpoint of adhesion at the interface between the epoxy resin and the inorganic filler.

### (Release Agent)

In the case where a mold is used for molding, the curable resin composition of the present disclosure may include a release agent from the viewpoint of releasability from the mold. The release agent is not particularly limited, and any conventionally known release agent can be used. Examples of the release agent include carnauba wax, higher fatty acids such as montanic acid and stearic acid, higher fatty acid metal salts, ester-based waxes such as montanic acid ester, polyolefin-based waxes such as oxidized polyethylene and non-oxidized polyethylene, etc. The release agent may be used alone or in combination of two or more.

In the case where the curable resin composition of the present disclosure includes a release agent, the content of the release agent is preferably 0.01 parts by mass to 15 parts by mass, and more preferably 0.1 parts by mass to 10 parts by mass, relative to 100 parts by mass of the epoxy resin included in the curable resin composition. When the amount of the release agent is 0.01 parts by mass or more relative to 100 parts by mass of the resin component, sufficient releasability tends to be obtained. When the amount is 15 parts by mass or less, better releasability tends to be obtained.

### (Colorant)

The curable resin composition of the present disclosure may include a colorant. Examples of the colorant include known colorants such as carbon black, organic dye, organic pigment, titanium oxide, red lead, red iron oxide, etc. The content of the colorant can be appropriately selected depending on the purpose or the like. The colorant may be used alone or in combination of two or more.

In the case where the curable resin composition includes a colorant, the content thereof is preferably 0.01% by mass to 5% by mass, and more preferably 0.05% by mass to 4% by mass.

### (Flame Retardant)

The curable resin composition of the present disclosure may include a flame retardant. The flame retardant is not particularly limited, and any known flame retardant can be used. Examples of the flame retardant include organic or inorganic compounds including a halogen atom, an antimony atom, a nitrogen atom or a phosphorus atom, metal hydroxides, etc. The flame retardant may be used alone or in combination of two or more.

In the case where the curable resin composition of the present disclosure includes a flame retardant, the content thereof is not particularly limited as long as the amount is sufficient to achieve the desired flame retardant effect. The content of the flame retardant is preferably 1 part by mass to 300 parts by mass, and more preferably 2 parts by mass to 150 parts by mass, relative to 100 parts by mass of the epoxy resin included in the curable resin composition.

### (Ion Exchanger)

The curable resin composition of the present disclosure may include an ion exchanger. In the case where the curable resin composition is used as a sealing material for a semiconductor package, the curable resin composition preferably includes an inorganic ion exchanger from the viewpoint of improving the moisture resistance and high-temperature storage characteristics of an electronic component device including an element to be sealed therein.

The ion exchanger is not particularly limited, and any conventionally known ion exchanger can be used. Specific examples include hydrotalcite compounds and hydrous oxides of at least one element selected from the group consisting of magnesium, aluminum, titanium, zirconium, and bismuth. The ion exchangers may be used alone or in combination of two or more. Specifically, the ion exchanger may be hydrotalcite represented by the following general formula (A).

Mg_{(1-X)}Al_{X}(OH)₂(CO₃)_{X/2}·mH₂O (A)

(0<X≤0.5, m is a positive number)

In the case where the curable resin composition of the present disclosure includes an ion exchanger, the content thereof is not particularly limited as long as the amount is sufficient to capture ions such as halogen ions. The content of the ion exchanger is preferably 0.1 parts by mass to 30 parts by mass, and more preferably 1 part by mass to 6 parts by mass, relative to 100 parts by mass of the epoxy resin included in the curable resin composition.

### (Physical Properties of Curable Resin Composition)

From the viewpoint of fluidity, the curable resin composition of the present disclosure preferably has a spiral flow, as determined by the following method, of 100 cm or more, more preferably 120 cm or more, even more preferably 140 cm or more, and particularly preferably 160 cm or more. The upper limit of the spiral flow is not particularly limited, and may be, for example, 170 cm or less.

The spiral flow is measured with use of a spiral flow measurement mold conforming to EMMI-1-66, and the flow distance is determined when the curable resin composition is molded under conditions of a mold temperature of 175° C., a molding pressure of 6.9 MPa, and a curing time of 90 seconds.

The gel time of the curable resin composition at 175° C. is preferably 15 seconds or more, more preferably 18 seconds or more, and even more preferably 21 seconds or more, from the viewpoints of fluidity and curability. Further, from the viewpoint of curability, the gel time is preferably 50 seconds or less, more preferably 47 seconds or less, and even more preferably 44 seconds or less.

The gel time is measured from the time when 0.5 g of the thermosetting resin composition is placed on a hot plate preheated to 175° C. to the time when the resin has lost viscosity. It is preferable to heat the resin while periodically stirring the resin with a spatula or the like. “The resin has lost viscosity” refers to the phenomenon in which the resin breaks or is destroyed when kneaded using a spatula or the like.

The viscosity of the curable resin composition of the present disclosure at 175° C. is preferably 0.01 Pa·s to 1,000 Pas, more preferably 0.1 Pa·s to 200 Pas, even more preferably 1 Pa·s to 50 Pa·s, and particularly preferably 1 Pa·s to 20 Pas. The viscosity of the curable resin composition at 175° C. is measured using a flow tester viscometer at a pressure of 1 MPa with a nozzle diameter of 1 mm and a length of 10 mm.

From the viewpoint of heat resistance, etc., the glass transition temperature (Tg) of the cured product of the curable resin composition is preferably 80° C. or higher, more preferably 85° C. or higher, and even more preferably 90° C. or higher. The upper limit of the Tg is not particularly limited, and may be 200° C. or lower, or 180° C. or lower.

In the present disclosure, the glass transition temperature of the cured product is defined as the temperature at the intersection point of the tangent line at 10° C. to 30° C. and the tangent line at 200° C. to 220° C., obtained by measuring the linear expansion coefficient.

From the viewpoints of moldability, handleability, etc. of the curable resin composition, the hot hardness of the cured product is preferably 56 or more, more preferably 58 or more, and even more preferably 60 or more. Furthermore, the upper limit of the hot hardness is not particularly limited, and may be 90 or less, 88 or less, 85 or less, 83 or less, or 80 or less.

The hot hardness (175° C.) of the cured product is measured using a Shore hardness tester Type D (for example, manufactured by Kobunshi Keiki Co., Ltd.) on a rectangular parallelepiped test piece for hot hardness measurement which has a size of 4 mm×80 mm×10 mm. The test piece is obtained by curing and molding the curable resin composition under conditions of 175° C., 120 seconds, and a pressure of 7 MPa using a transfer molding machine and a disk mold. The measurement is carried out in a press immediately after preparation of the test piece.

From the viewpoints of moldability, handleability, etc. of the curable resin composition, the hot strength of the cured product is preferably 3 MN/m² or more, more preferably 4 MN/m² or more, and even more preferably 5 MN/m² or more. Further, the upper limit of the hot strength is not particularly limited, and may be 20 MN/m² or less, 18 MN/m² or less, or 16 MN/m² or less.

The hot strength of the cured product is measured using a load tester (for example, Aikoh Engineering Co., Ltd., tabletop tester 1301K) on a rectangular parallelepiped test piece for hot strength measurement which has a size of 4 mm×80 mm×10 mm. The test piece is obtained by curing and molding the curable resin composition under conditions of 175° C., 120 seconds, and a pressure of 7 MPa using a transfer molding machine and a disk mold.

From the viewpoint of adhesion of the cured product to a lead frame, the elastic modulus of the cured product of the first curable resin composition or the second curable resin composition at 260° C. varies depending on the amount of filler, but is preferably 1,000 MPa or less, more preferably 900 MPa or less, and even more preferably 800 MPa or less.

From the viewpoint of adhesion of the cured product to a lead frame, the adhesive strength of the cured product of the first curable resin composition or the second curable resin composition to Ag (silver) is preferably 0.3 MPa or more, more preferably 0.35 MPa or more, and even more preferably 0.4 MPa or more. In addition, the upper limit of the adhesive strength is not particularly limited.

From the viewpoint of suppressing the occurrence of warping of the package of the cured product, the linear expansion coefficient of the cured product of the first curable resin composition or the second curable resin composition at 180° C. to 200° C. is preferably 25 ppm/° C. or more, more preferably 28 ppm/° C. or more, and even more preferably 31 ppm/° C. or more. It was previously considered that the smaller the linear expansion coefficient, the more likely it was to suppress peeling from the lead frame. However, it has been found that the first curable resin composition or the second curable resin composition of the present disclosure is effective in suppressing peeling from the lead frame when the linear expansion coefficient of the cured product at 180° C. to 200° C. is 31 ppm/° C. or more. The reason for this is not clear, but it is presumed to be the effect of thermal stress reduction due to suppression of warping caused by the difference in linear expansion coefficient between the members. In particular, with the first curable resin composition or the second curable resin composition of the present disclosure, it is possible to lower the glass transition temperature (Tg), which can widen the allowable range of the linear expansion coefficient.

From the viewpoint of suppressing generation of thermal stress with the package members, the upper limit of the linear expansion coefficient is preferably 60 ppm/° C. or less, more preferably 55 ppm/° C. or less, and even more preferably 50 ppm/° C. or less.

### (Method for Producing Curable Resin Composition)

The method for producing the curable resin composition is not particularly limited. A typical method involves, for example, thoroughly mixing the components in predetermined amounts using a mixer or the like, melt-kneading the mixture using a mixing roll, an extruder, or the like, cooling, and pulverizing the mixture. More specifically, for example, the above-mentioned components are mixed in predetermined amounts by stirring, kneaded in a kneader, a roll, an extruder, or the like that has been preheated to 70° C. to 140° C., cooled, and pulverized.

The curable resin composition is preferably a solid at 25° C. In the case where the curable resin composition is a solid at 25° C., the shape of the curable resin composition is not particularly limited, and examples of the shape include powder, granules, tablets, or the like. In the case where the curable resin composition is in the form of tablets, the dimensions and mass are preferably set to suit the molding conditions of the package from the viewpoint of handleability.

### (Application of Curable Resin Composition)

The application of the curable resin composition of the present disclosure is not particularly limited, and the curable resin composition can be used, for example, as a sealing material for an electronic component device in various mounting techniques. In addition, the curable resin composition of the present disclosure can be used in various applications in which it is desirable for the resin composition to have good fluidity and curability, such as resin molded articles for various modules, resin molded articles for motors, resin molded articles for in-vehicle use, sealing materials for protective materials for electronic circuits, etc.

### <Electronic Component Device>

An electronic component device of the present disclosure includes an element and a cured product of the curable resin composition that seals the element.

The electronic component device may include a support member on which the element is mounted.

Examples of the support member include a lead frame, a pre-wired tape carrier, a wiring board, glass, a silicon wafer, an organic substrate, etc. Among the above support members, a lead frame is preferable from the viewpoint of adhesion to the cured product of the curable resin composition.

The lead frame may or may not have a roughened surface, but from the viewpoint of manufacturing costs, a lead frame is preferable, and from the viewpoint of adhesion, a roughened lead frame is preferable.

The roughening method is not particularly limited, and examples thereof include alkali treatment, silane coupling treatment, sand matt treatment, plasma treatment, corona discharge treatment, etc.

The lead frame preferably includes Ag, and may further include Cu or the like.

Examples of the element included in the electronic component device include active elements such as silicon chips, transistors, diodes, and thyristors, and passive elements such as capacitors, resistors, and coils.

Specific configurations of the electronic component device include, but are not limited to, the following configurations.
(1) General resin-sealed ICs such as DIP (Dual Inline Package), PLCC (Plastic Leaded Chip Carrier), QFP (Quad Flat Package), SOP (Small Outline Package), SOJ (Small Outline J-lead Package), TSOP (Thin Small Outline Package), and TQFP (Thin Quad Flat Package) that have a structure in which an element is fixed on a lead frame, and the terminal portions of the element such as bonding pads and the lead portions are connected using wire bonding, bumps, or the like, and then sealed using a curable resin composition;
(2) TCP (Tape Carrier Package) having a structure in which an element connected to a tape carrier using bumps is sealed using a curable resin composition;
(3) COB (Chip On Board) modules, hybrid ICs, multi-chip modules, etc., having a structure in which an element connected to the wiring formed on a support member by wire bonding, flip chip bonding, solder, or the like is sealed using a curable resin composition; and
(4) BGA (Ball Grid Array), CSP (Chip Size Package), MCP (Multi Chip Package), SiP (System in a Package), etc., having a structure in which an element is mounted on the surface of a support member which has terminals for connecting a wiring board formed on the back surface thereof, the element is connected to wiring formed on the support member using bumps or wire bonding, and then the element is sealed using a curable resin composition.

The method for sealing an element using the curable resin composition is not particularly limited, and any known method can be applied. For example, low-pressure transfer molding is generally used as the sealing method, but injection molding, compression molding, casting, or the like may also be used.

### EXAMPLES

The present disclosure will be specifically described hereinafter with reference to examples, but the present disclosure is not limited to these examples. Furthermore, unless otherwise specified, the numerical values in the tables refer to “parts by mass.”

### Examples 1A and 2A and Comparative Examples 1A to 5A

The materials having the composition shown in Table 1 were premixed (dry blended), and then kneaded for about 15 minutes with a biaxial roll (roll surface temperature: about 80° C.), cooled, and pulverized to produce a powdered curable resin composition. The equivalent ratio of the phenolic hydroxyl group (active hydrogen) of the phenol-based curing agent to the epoxy group of the epoxy resin was 0.7.

Details of the materials in Table 1 are as follows.
Epoxy resin A: biphenyl type, epoxy equivalent 192 g/eq
Epoxy resin B: sulfur atom-containing epoxy resin, epoxy equivalent 238 g/eq to 254 g/eq, melting point 116° C. to 126° C.
Epoxy resin C: triphenylmethane type (but having no alkyl group or alkoxy group), epoxy equivalent 169 g/mol, softening point 60° C.
Epoxy resin D: orthocresol type, epoxy equivalent 200 g/eq
Epoxy resin E: triphenylmethane type (but having no alkyl group or alkoxy group), epoxy equivalent 165 g/eq, melting point 104° C.
Epoxy resin F: triphenylmethane type epoxy resin represented by the above formula (2), epoxy equivalent 214 g/eq, melting point 85° C.
Curing agent A: phenol resin, hydroxyl group equivalent 175 g/eq
Curing agent B: triphenylmethane type phenol resin, hydroxyl group equivalent 104 g/eq
Curing agent C: alkyl-modified phenol resin, hydroxyl group equivalent 224 g/eq
Curing agent D: aminotriazine-modified phenol resin, amine equivalent 120 g/eq
Curing accelerator: 1,4-benzoquinone adduct of triphenylphosphine
Inorganic filler: spherical silica particles with a top cut of 75 μm and a volume average particle size of 19 μm
Coupling agent A: N-phenyl-3-aminopropyltrimethoxysilane
Coupling agent B: 3-glycidoxypropyltrimethoxysilane
Coupling agent C: 3-mercaptopropyltrimethoxysilane
Release agent: ester-based wax such as montanic acid ester
Colorant: carbon black
Ion exchanger: hydrotalcite
Stress reliever A: methyl/phenyl-based polysiloxane compound, solid at 25° C.
Stress reliever B: triphenylphosphine oxide.
Stress reliever C: coumarone resin, softening point 100° C.
Stress reliever D: specific branched polysiloxane with an epoxy equivalent of 1660 and a softening point of 80° C.

### <<Evaluation of Curable Resin Composition>:

The characteristics of the curable resin compositions prepared in the examples and comparative examples were measured and evaluated by the following methods. The evaluation results are shown in Table 2.

### <Measurement of Spiral Flow>

The spiral flow of the curable resin composition was measured by the method described above.

### <Measurement of Gel Time>

The gel time of the curable resin composition was measured by the method described above.

### <Measurement of Viscosity>

The viscosity of the curable resin composition at 175° C. was measured by the method described above.

### <Measurement of Linear Expansion Coefficient>

The thermal expansion coefficient at 180° C. to 200° C. of the cured product of the curable resin composition was measured by the method described above. TMA/SS6100 manufactured by Seiko Instruments Inc. was used as the thermomechanical analyzer.

### <Glass Transition Temperature (Tg) of Cured Product>

The temperature at the intersection point of the tangent line at 10° C. to 30° C. and the tangent line at 200° C. to 220° C., obtained by the above linear expansion coefficient measurement, was taken as the glass transition temperature of the cured product.

### <Measurement of Elastic Modulus>

The thermal expansion coefficient at 260° C. of the cured product of the curable resin composition was measured by the method described above. RSAIII manufactured by TA Instruments was used as the viscoelasticity measuring device.

### <Measurement of Adhesive Strength to Ag (Silver)>

The adhesive strength of the cured product of the curable resin composition to Ag (silver) was measured by the method described above. Product name 4000 Optima manufactured by Nordson Corporation was used as the measuring device.

### <Measurement of Hot Hardness>

The hot hardness of the cured product of the curable resin composition was measured by the method described above. A Shore hardness tester Type D manufactured by Kobunshi Keiki Co., Ltd. was used as the measuring device.

### <Measurement of Hot Strength>

The hot strength of the cured product of the curable resin composition was measured by the method described above. A tabletop tester 1301K manufactured by Aikoh Engineering Co., Ltd. was used as the measuring device.

<Evaluation of Peelability when Absorbing Moisture at High Temperature>

An 80-pin flat package (lead frame material: AgCu) with external dimensions of 20 mm in length, 14 mm in width, and 2 mm in thickness was produced, which was equipped with a silicon chip (8 mm in length, 10 mm in width, and 0.4 mm in thickness) sealed using the cured product of the curable resin composition formed under the above conditions.

The above package was heated under two conditions: 85° C., 85% RH for 168 hours (MSL1), and 85° C., 60% RH for 168 hours (MSL2).

Thereafter, reflow treatment was performed for 10 seconds at 260° C., and whether peeling occurred inside the package was observed with an ultrasonic flaw detector (HYE-FOCUS, manufactured by Hitachi Construction Machinery Co., Ltd.). The peelability was evaluated based on the number of packages in which peeling occurred out of the total number of packages under test (16).

TABLE 1

| | | Comparative | Comparative | Comparative | Comparative | Comparative | | |
|---|---|---|---|---|---|---|---|---|
| | | Example 1A | Example 2A | Example 3A | Example 4A | Example 5A | Example 1A | Example 2A |
| | A | 31 | 20 | 20 | 20 | 20 | 20 | 20 |
| | B | 69 | 80 | 45 | 45 | 45 | 45 | 45 |
| | C | | | 35 | | | | |
| | D | | | | 35 | | | |
| | E | | | | | 35 | | |
| | F | | | | | | 35 | 35 |
| Curing agent | A | 43.8 | 24.2 | 28.4 | 26.7 | 25.7 | 28.7 | 28.7 |
| | B | | 14.6 | 16.7 | 15.7 | 16.9 | 15.1 | 15.1 |
| | C | 8 | 5 | 5 | 5 | 5 | 5 | 5 |
| | D | 3 | | | | | | |
| Curing accelerator | | 3.5 | 3.2 | 2.8 | 3.3 | 3.1 | 3.2 | 3.2 |
| Coupling agent | A | 3 | 3 | 3 | 3 | 3 | 3 | 3 |
| | B | 3 | 3 | 3 | 3 | 3 | 3 | 3 |
| | C | 3 | 5 | 5 | 5 | 5 | 5 | 5 |
| Release agent | | 3 | 3 | 3 | 3 | 3 | 3 | 3 |
| Colorant | | 3 | 3 | 3 | 3 | 3 | 3 | 3 |
| Ion exchanger | | 3 | 3 | 3 | 3 | 3 | 3 | 3 |
| Stress reliever | A | 20 | 20 | 20 | 20 | 20 | 20 | |
| | B | 10 | 10 | 10 | 10 | 10 | 10 | 10 |
| | C | 10 | 10 | 10 | 10 | 10 | 10 | 10 |
| | D | | | | | | | 20 |

| | | | | | | | |
|---|---|---|---|---|---|---|---|
| Filler amount | 78 | 75 | 75 | 75 | 75 | 75 | 75 |
| (% by volume) | | | | | | | |

TABLE 2

| | | Comparative | Comparative | Comparative | Comparative | Comparative | | |
|---|---|---|---|---|---|---|---|---|
| | | Example 1A | Example 2A | Example 3A | Example 4A | Example 5A | Example 1A | Example 2A |
| Spiral flow | cm | 127 | 201 | 132 | 152 | 122 | 163 | 167 |
| Gel time | second | 32 | 32 | 25 | 25 | 26 | 27 | 27 |
| Viscosity | Pa · s | 5 | 4 | 5 | 5 | 4 | 4 | 4 |
| Linear expansion | ppm/° C. | 38.3 | 43.0 | 34.3 | 29.5 | 35.1 | 38.6 | 38.1 |
| coefficient | | | | | | | | |
| Tg | ° C. | 102 | 110 | 118 | 116 | 115 | 119 | 122 |
| Elastic modulus | MPa | 310 | 160 | 465 | 472 | 381 | 380 | 394 |
| (260° C.) | | | | | | | | |
| Adhesive strength | MPa | 0.45 | 0.55 | 0.45 | 0.47 | 0.47 | 0.45 | 0.46 |
| to Ag | | | | | | | | |
| Hot hardness | | 52 | 55 | 69 | 68 | 65 | 63 | 61 |
| Hot strength | MN/m² | 2.4 | 3.5 | 7.1 | 7.1 | 6.5 | 6.5 | 6.2 |
| MSL1 | number/number | 9/16 | 3/16 | 16/16 | 10/16 | 13/16 | 0/16 | 0/16 |
| MSL2 | number/number | 0/16 | 0/16 | 0/16 | 0/16 | 0/16 | 0/16 | 0/16 |

As shown in Table 2, under the moisture absorption conditions of 85° C. and 60% RH, no difference in peelability was observed between the comparative examples and the examples. However, under the severe moisture absorption conditions of 85° C. and 85% RH, peeling was significantly suppressed in the examples compared to the comparative examples.

### Examples 1B to 2B and Comparative Examples 1B to 2B

The materials having the composition shown in Table 3 were premixed (dry blended), and then kneaded for about 15 minutes with a biaxial roll (roll surface temperature: about 80° C.), cooled, and pulverized to produce a powdered curable resin composition. The equivalent ratio of the phenolic hydroxyl group (active hydrogen) of the phenol-based curing agent to the epoxy group of the epoxy resin was 0.7.

Details of the materials in Table 3 are as follows.
Epoxy resin A: biphenyl type, epoxy equivalent 192 g/eq
Epoxy resin B: sulfur atom-containing epoxy resin, epoxy equivalent 238 g/eq to 254 g/eq, melting point 116° C. to 126° C.
Epoxy resin C: triphenylmethane type (but having no alkyl group or alkoxy group), epoxy equivalent 169 g/mol, softening point 60° C.
Epoxy resin D: orthocresol type, epoxy equivalent 200 g/eq
Epoxy resin E: triphenylmethane type epoxy resin represented by the above formula (2), epoxy equivalent of 214 g/eq, melting point of 85° C.
Curing agent A: phenolic resin, hydroxyl group equivalent 175 g/eq
Curing agent B: triphenylmethane type phenol resin, hydroxyl group equivalent 104 g/eq
Curing agent C: alkyl-modified phenol resin, hydroxyl group equivalent 224 g/eq
Curing accelerator: 1,4-benzoquinone adduct of triphenylphosphine
Inorganic filler: spherical silica particles with a top cut of 75 μm and a volume average particle size of 19 μm
Coupling agent A: N-phenyl-3-aminopropyltrimethoxysilane
Coupling agent B: 3-glycidoxypropyltrimethoxysilane
Coupling agent C: 3-mercaptopropyltrimethoxysilane
Release agent: ester-based wax such as montanic acid ester
Colorant: carbon black
Ion exchanger: hydrotalcite
Stress reliever A: methyl/phenyl-based polysiloxane compound, solid at 25° C.
Stress reliever B: triphenylphosphine oxide
Stress reliever C: coumarone resin, softening point 100° C.

### <<Evaluation of Curable Resin Composition>>

The characteristics of the curable resin compositions prepared in the examples and comparative examples were measured and evaluated by the above-mentioned methods. The evaluation results are shown in Table 4.

TABLE 3

| | | Exam- | Exam- | Comparative | Comparative |
|---|---|---|---|---|---|
| | | ple 1B | ple 2B | Example 1B | Example 2B |
| Epoxy resin | A | 20 | 20 | 20 | 20 |
| | B | 45 | 80 | 45 | 45 |
| | C | | | 35 | |
| | D | | | | 35 |
| | E | 35 | | | |
| Curing agent | A | 28.7 | 24.2 | 28.4 | 26.7 |
| | B | 15.1 | 14.6 | 16.7 | 15.7 |
| | C | 5 | 5 | 5 | 5 |
| Curing accelerator | | | 3.5 | 3.2 | 3.3 |
| Coupling agent | A | 3 | 3 | 3 | 3 |
| | B | 3 | 3 | 3 | 3 |
| | C | 5 | 5 | 5 | 5 |
| Release agent | | 3 | 3 | 3 | 3 |
| Colorant | | 3 | 3 | 3 | 3 |
| Ion exchanger | | 3 | 3 | 3 | 3 |
| Stress reliever | A | 20 | 20 | 20 | 20 |
| | B | 10 | 10 | 10 | 10 |
| | C | 10 | 10 | 10 | 10 |

| | | | | |
|---|---|---|---|---|
| Inorganic filler amount | 75 | 78 | 75 | 75 |
| (% by volume) | | | | |

TABLE 4

| | | | | Compar- | Compar- |
|---|---|---|---|---|---|
| | | | | ative | ative |
| | | Exam- | Exam- | Exam- | Exam- |
| | | ple 1B | ple 2B | ple 1B | ple 2B |
| Spiral flow | Cm | 163 | 201 | 132 | 152 |
| Gel time | Second | 27 | 32 | 25 | 25 |
| Viscosity | Pa · s | 4 | 4 | 5 | 5 |
| Linear expansion | ppm/° C. | 38.6 | 43.0 | 34.3 | 29.5 |
| coefficient | | | | | |
| Tg | ° C. | 119 | 110 | 118 | 116 |
| Elastic modulus | MPa | 380 | 160 | 465 | 472 |
| (260° C.) | | | | | |
| Adhesive strength | MPa | 0.45 | 0.55 | 0.45 | 0.47 |
| to Ag | | | | | |
| Hot hardness | | 63 | 55 | 69 | 68 |
| Hot strength | MN/m² | 6.5 | 3.5 | 7.1 | 7.1 |
| MSL1 | number/ | 0/16 | 0/16 | 16/16 | 10/16 |
| | number | | | | |
| MSL2 | number/ | 0/16 | 0/16 | 0/16 | 0/16 |
| | number | | | | |

As shown in Table 4, under moisture absorption conditions of 85° C. and 60% RH (MSL2), no difference in peelability was observed between the comparative examples and the examples, and it can be seen that the invention of the present disclosure could not be easily achieved under normal moisture absorption conditions. It can also be seen that under severe moisture absorption conditions of 85° C. and 85% RH (MSL1), peeling was significantly suppressed in the examples compared to the comparative examples. In particular, in Examples 1B and 2B, no package experienced peeling even under the severe moisture absorption conditions of MSL1, and particularly excellent effects were achieved.

The entirety of the disclosures of Japanese Patent Application No. 2022-201454, 2022-201455, and 2022-201456 is incorporated into the present disclosure by reference.

All the documents, patent applications, and standards mentioned in the present disclosure are incorporated by reference into the present disclosure to the same extent as if each individual document, patent application, and standard is specifically and individually incorporated by reference.

1. A curable resin composition, comprising a triphenylmethane type epoxy resin having at least one selected from a group consisting of an alkyl group and an alkoxy group.

2. The curable resin composition according to claim 1, wherein a benzene ring included in the triphenylmethane type epoxy resin has two or more alkyl groups.

3. The curable resin composition according to claim 1, wherein a benzene ring included in a main chain of the triphenylmethane type epoxy resin has two or more alkyl groups.

4. The curable resin composition according to claim 1, wherein the alkyl group comprises a t-butyl group.

5. The curable resin composition according to claim 1, further comprising a polysiloxane-based stress reliever.

6. The curable resin composition according to claim 5, wherein the polysiloxane-based stress reliever comprises a branched polysiloxane having the following structural units (a) and (b), a terminal of which is at least one functional group selected from a group consisting of R¹, a hydroxyl group, and an alkoxy group, and having an epoxy equivalent of 500 g/eq to 4,000 g/eq, 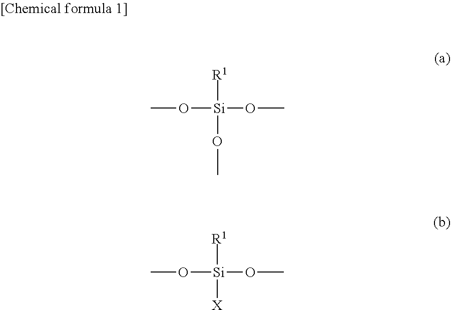
R¹ represents an unsubstituted alkyl group, alkenyl group, aryl group, or aralkyl group having 1 to 12 carbon atoms, and in a case where a plurality of R¹ are present in the branched polysiloxane, the plurality of R¹ may be the same or different; X represents a 2,3-epoxypropyl group, a 3,4-epoxybutyl group, a 4,5-epoxypentyl group, a 2-glycidoxyethyl group, a 3-glycidoxypropyl group, a 4-glycidoxybutyl group, a 2-(3,4-epoxycyclohexyl)ethyl group, or a 3-(3,4-epoxycyclohexyl)propyl group.

7. A curable resin composition, having an elastic modulus at 260° C. of 400 MPa or less when made into a cured product, a linear expansion coefficient at 180° C. to 200° C. of 32 ppm/° C. or more when made into a cured product, and an adhesive strength of the cured product to Ag (silver) after treatment at 85° C. and 85% RH of 0.45 MPa or more.

8. The curable resin composition according to claim 7, having a spiral flow according to EMMI-1-66 of 100 cm or more.

9. The curable resin composition according to claim 7, having a hot hardness of 56 or more when made into a cured product.

10. The curable resin composition according to claim 7, having a hot strength of 3 MN/m² or more when made into a cured product.

11. An electronic component device, comprising an element; and a cured product of the curable resin composition according to claim 1 that seals the element.

12. The electronic component device according to claim 11, comprising a lead frame mounting the element on one surface.

13. The electronic component device according to claim 12, wherein the lead frame comprises Ag.

14. An electronic component device, comprising an element; and a cured product of the curable resin composition according to claim 7 that seals the element.

15. The electronic component device according to claim 14, comprising a lead frame mounting the element on one surface.

16. The electronic component device according to claim 15, wherein the lead frame comprises Ag.
